(19) United States
(12) Patent Application Publication
(10) Pub. No.: US 2022/0373635 A1
(43) Pub. Date: Nov. 24, 2022

(54) BEAM MANAGEMENT IN POSITIONING SIGNALING

(71) Applicant: QUALCOMM Incorporated, San Diego, CA (US)

(72) Inventors: Jingchao BAO, San Diego, CA (US); Sony AKKARAKARAN, Poway, CA (US); Alexandros MANOLAKOS, Escondido, CA (US); Tao LUO, San Diego, CA (US)

(21) Appl. No.: 17/759,430

(22) PCT Filed: Feb. 4, 2021
(86) PCT No.: PCT/US2021/016518

§ 371 Date: Jul. 25, 2022

(30) Foreign Application Priority Data
Feb. 14, 2020 (GR) 20200100075

(51) Int. Cl. G01S 5/00; H04L 5/00; H04W 16/28

(52) U.S. Cl. CPC G01S 5/0063; H04L 5/0051; H04W 16/28

(57) ABSTRACT

Disclosed are techniques for wireless communication. In an aspect, a user equipment (UE) receives, on a first downlink receive beam, one or more first positioning reference signals (PRS) transmitted by a first base station on a first downlink transmit beam, attempts to receive, on the first downlink receive beam, one or more second PRS transmitted by a set of base stations, other than the first base station, on a set of downlink transmit beams other than the first downlink transmit beam, determines that one or more signal strength measurements of the one or more second PRS received on the first downlink receive beam are below a threshold, and transmits a request to update the set of downlink transmit beams or the first downlink transmit beam, or to establish a new beam pairing with the first base station, the set of base stations, or both.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes receiving, on a first downlink receive beam, one or more first positioning reference signals (PRS) transmitted by a first base station on a first downlink transmit beam, attempting to receive, on the first downlink receive beam, one or more second PRS transmitted by a set of base stations, other than the first base station, on a set of downlink transmit beams other than the first downlink transmit beam, determining that one or more signal strength measurements of the one or more second PRS received on the first downlink receive beam are below a threshold, and transmitting a request to update the set of downlink transmit beams, or to establish a new beam pairing with the first base station, the set of base stations, or both.

In an aspect, a method of communication performed by a location server includes configuring a UE to measure one or more first PRS transmitted by a first base station on a first downlink transmit beam and one or more second PRS transmitted by a set of base stations, other than the first base station, on a set of downlink transmit beams other than the first downlink transmit beam, and receiving a request to update the set of downlink transmit beams, or to establish a new beam pairing with the first base station, the set of base stations, or both.

In an aspect, a method of wireless communication performed by a UE includes receiving, from a network entity, a first PRS configuration for a plurality of PRS transmitted by a corresponding plurality of base stations, wherein the plurality of PRS are frequency-division multiplexed with each other, determining a downlink receive beam for each of the plurality of base stations, determining a second PRS configuration for the plurality of PRS that enables the UE to use a same downlink receive beam for at least two of the plurality of base stations within a same time interval, and transmitting, to the network entity, a request to update the first PRS configuration to the second PRS configuration.

In an aspect, a method of communication performed by a location server includes transmitting, to a network node, a first PRS configuration for a plurality of PRS transmitted by a corresponding plurality of base stations, wherein the plurality of PRS are frequency-division multiplexed with each other, and receiving, from the network node, a request to update the first PRS configuration to a second PRS configuration for the plurality of PRS, wherein the second PRS configuration enables a UE to use a same downlink receive beam for at least two of the plurality of base stations within a same time interval.

In an aspect, a UE includes a memory, at least one transceiver, and at least one processor communicatively coupled to the memory and the at least one transceiver, the at least one processor configured to: receive, via the at least one transceiver on a first downlink receive beam, one or more first PRS transmitted by a first base station on a first downlink transmit beam, attempt to receive, via the at least one transceiver on the first downlink receive beam, one or more second PRS transmitted by a set of base stations, other than the first base station, on a set of downlink transmit beams other than the first downlink transmit beam, determine that one or more signal strength measurements of the one or more second PRS received on the first downlink receive beam are below a threshold, and cause the at least one transceiver to transmit a request to update the set of downlink transmit beams, or to establish a new beam pairing with the first base station, the set of base station, or both.

In an aspect, a location server includes a memory, at least one network interface, and at least one processor communicatively coupled to the memory and the at least one network interface, the at least one processor configured to: configure, via the at least one network interface, a UE to measure one or more first PRS transmitted by a first base station on a first downlink transmit beam and one or more second PRS transmitted by a set of base stations, other than the first base station, on a set of downlink transmit beams other than the first downlink transmit beam, and receive, via the at least one network interface, a request to update the set of downlink transmit beams, or to establish a new beam pairing with the first base station, the set of base stations, or both.

In an aspect, a UE includes a memory, at least one transceiver, and at least one processor communicatively coupled to the memory and the at least one transceiver, the at least one processor configured to: receive, from a network entity via the at least one transceiver on, a first PRS configuration for a plurality of PRS transmitted by a corresponding plurality of base stations, wherein the plurality of PRS are frequency-division multiplexed with each other, determine a downlink receive beam for each of the plurality of base stations, determine a second PRS configuration for the plurality of PRS that enables the UE to use a same downlink receive beam for at least two of the plurality of base stations within a same time interval, and cause the at least one transceiver to transmit, to the network entity, the second PRS configuration for the plurality of PRS.

In an aspect, a location server includes a memory, at least one network interface, and at least one processor communicatively coupled to the memory and the at least one network interface, the at least one processor configured to: cause the at least one network interface to transmit, to a network node, a first PRS configuration for a plurality of PRS transmitted by a corresponding plurality of base stations, wherein the plurality of PRS are frequency-division multiplexed with each other, and receive, from the network node via the at least one network interface, a request to update the first PRS configuration to a second PRS configuration for the plurality of PRS, wherein the second PRS configuration enables a UE to use a same downlink receive beam for at least two of the plurality of base stations within a same time interval.

In an aspect, a UE includes means for receiving, on a first downlink receive beam, one or more first PRS transmitted by a first base station on a first downlink transmit beam, means for attempting to receive, on the first downlink receive beam, one or more second PRS transmitted by a set of base stations, other than the first base station, on a set of downlink transmit beams other than the first downlink transmit beam, means for determining that one or more signal strength measurements of the one or more second PRS received on the first downlink receive beam are below a threshold, and means for transmitting a request to update the set of downlink transmit beams, or to establish a new beam pairing with the first base station, the set of base stations, or both.

In an aspect, a location server includes means for configuring a UE to measure one or more first PRS transmitted by a first base station on a first downlink transmit beam and one or more second PRS transmitted by a set of base stations, other than the first base station, on a set of downlink transmit beams other than the first downlink transmit beam, and means for receiving a request to update the set of downlink transmit beams, or to establish a new beam pairing with the first base station, the set of base stations, or both.

In an aspect, a UE includes means for receiving, from a network entity, a first PRS configuration for a plurality of PRS transmitted by a corresponding plurality of base stations, wherein the plurality of PRS are frequency-division multiplexed with each other, means for determining a downlink receive beam for each of the plurality of base stations, means for determining a second PRS configuration for the plurality of PRS that enables the UE to use a same downlink receive beam for at least two of the plurality of base stations within a same time interval, and means for transmitting, to the network entity, the second PRS configuration for the plurality of PRS.

In an aspect, a location server includes means for transmitting, to a network node, a first PRS configuration for a plurality of PRS transmitted by a corresponding plurality of base stations, wherein the plurality of PRS are frequency-division multiplexed with each other, and means for receiving, from the network node, a request to update the first PRS configuration to a second PRS configuration for the plurality of PRS, wherein the second PRS configuration enables a UE to use a same downlink receive beam for at least two of the plurality of base stations within a same time interval.

In an aspect, a non-transitory computer-readable medium storing computer-executable instructions includes computer-executable instructions comprising at least one instruction instructing a UE to receive, on a first downlink receive beam, one or more first PRS transmitted by a first base station on a first downlink transmit beam, at least one instruction instructing the UE to attempt to receive, on the first downlink receive beam, one or more second PRS transmitted by a set of base stations, other than the first base station, on a set of downlink transmit beams other than the first downlink transmit beam, at least one instruction instructing the UE to determine that one or more signal strength measurements of the one or more second PRS received on the first downlink receive beam i below corresponding thresholds, and at least one instruction instructing the UE to transmit a request to update the set of downlink transmit beams, or to establish a new beam pairing with the first base station, the set of base stations, or both.

In an aspect, a non-transitory computer-readable medium storing computer-executable instructions includes computer-executable instructions comprising at least one instruction instructing a location server to configure a UE to measure one or more first PRS transmitted by a first base station on a first downlink transmit beam and one or more second PRS transmitted by a set of base stations, other than the first base station, on a set of downlink transmit beams other than the first downlink transmit beam, and at least one instruction instructing the location server to receive a request to update the set of downlink transmit beams, or to establish a new beam pairing with the first base station, the set of base stations, or both.

In an aspect, a non-transitory computer-readable medium storing computer-executable instructions includes computer-executable instructions comprising at least one instruction instructing a UE to receive, from a network entity, a first PRS configuration for a plurality of PRS transmitted by a corresponding plurality of base stations, wherein the plurality of PRS are frequency-division multiplexed with each other, at least one instruction instructing the UE to determine a downlink receive beam for each of the plurality of base stations, at least one instruction instructing the UE to determine a second PRS configuration for the plurality of PRS that enables the UE to use a same downlink receive beam for at least two of the plurality of base stations within a same time interval, and at least one instruction instructing the UE to transmit, to the network entity, the second PRS configuration for the plurality of PRS.

In an aspect, a non-transitory computer-readable medium storing computer-executable instructions includes computer-executable instructions comprising at least one instruction instructing a location server to transmit, to a network node, a first PRS configuration for a plurality of PRS transmitted by a corresponding plurality of base stations, wherein the plurality of PRS are frequency-division multiplexed with each other, and at least one instruction instructing the location server to receive, from the network node, a request to update the first PRS configuration to a second PRS configuration for the plurality of PRS, wherein the second PRS configuration enables a UE to use a same downlink receive beam for at least two of the plurality of base stations within a same time interval.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A to 3C are simplified block diagrams of several sample aspects of components that may be employed in a user equipment (UE), a base station, and a network entity, respectively, and configured to support communications as taught herein.

FIGS. 4A and 4B illustrate user plane and control plane protocol stacks, according to aspects of the disclosure.

FIGS. 5A and 5B are diagrams illustrating an example frame structure and channels within the frame structure, according to aspects of the disclosure.

FIG. 6 illustrates an example positioning reference signal (PRS) configuration for a cell supported by a wireless node.

FIGS. 7A and 7B illustrates various comb patterns for downlink PRS that a UE may support, according to aspects of the disclosure.

FIGS. 8A and 8B illustrate example random access procedures, according to aspects of the disclosure.

FIG. 9 is a diagram illustrating an example base station in communication with an example UE, according to aspects of the disclosure.

FIG. 10 is a graph showing a radio frequency (RF) channel impulse response over time, according to aspects of the disclosure.

FIG. 11 is a diagram of an example physical layer procedure for processing PRS transmitted on multiple beams, according to aspects of the disclosure.

FIG. 12 is a diagram of an example random access-based beam failure recovery procedure, according to aspects of the disclosure.

FIGS. 13 to 16 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

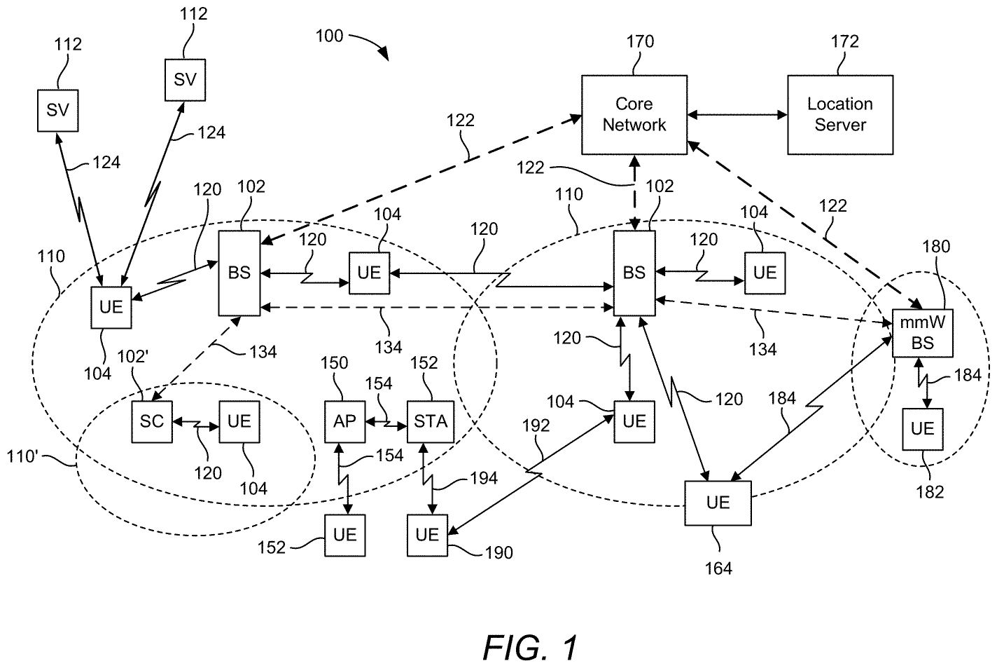

FIG. 1 illustrates an example wireless communications system 100. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell (SC) base station 102′ may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a target reference RF signal on a target beam can be derived from information about a source reference RF signal on a source beam. If the source reference RF signal is QCL Type A, the receiver can use the source reference RF signal to estimate the Doppler shift, Doppler spread, average delay, and delay spread of a target reference RF signal transmitted on the same channel. If the source reference RF signal is QCL Type B, the receiver can use the source reference RF signal to estimate the Doppler shift and Doppler spread of a target reference RF signal transmitted on the same channel. If the source reference RF signal is QCL Type C, the receiver can use the source reference RF signal to estimate the Doppler shift and average delay of a target reference RF signal transmitted on the same channel. If the source reference RF signal is QCL Type D, the receiver can use the source reference RF signal to estimate the spatial receive parameter of a target reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a base station. The UE can then form a transmit beam for sending one or more uplink reference signals (e.g., uplink positioning reference signals (UL-PRS), sounding reference signal (SRS), demodulation reference signals (DMRS), PTRS, etc.) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In the example of FIG. 1, one or more Earth orbiting satellite positioning system (SPS) space vehicles (SVs) 112 (e.g., satellites) may be used as an independent source of location information for any of the illustrated UEs (shown in FIG. 1 as a single UE 104 for simplicity). A UE 104 may include one or more dedicated SPS receivers specifically designed to receive SPS signals 124 for deriving geo location information from the SVs 112. An SPS typically includes a system of transmitters (e.g., SVs 112) positioned to enable receivers (e.g., UEs 104) to determine their location on or above the Earth based, at least in part, on signals (e.g., SPS signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104.

The use of SPS signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, an SPS may include any combination of one or more global and/or regional navigation satellite systems and/or augmentation systems, and SPS signals 124 may include SPS, SPS-like, and/or other signals associated with such one or more SPS.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

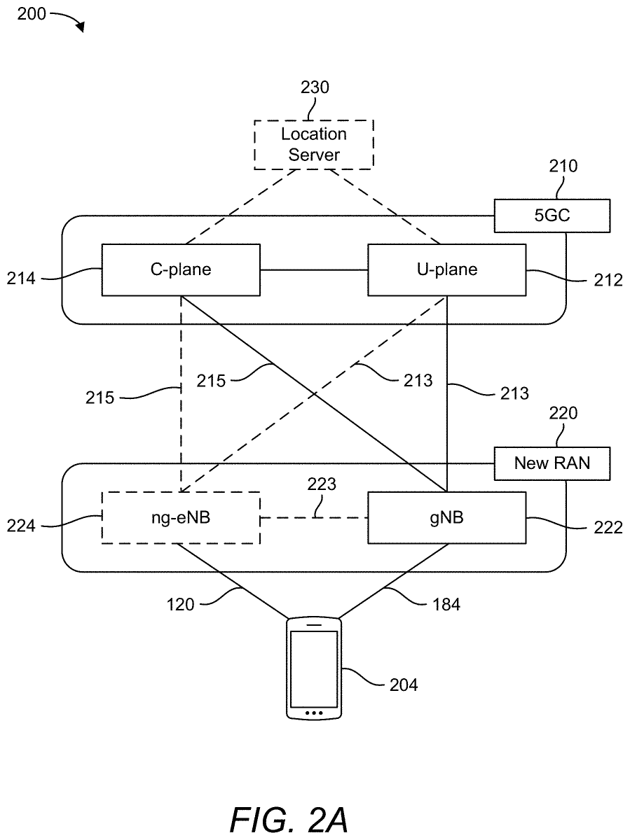

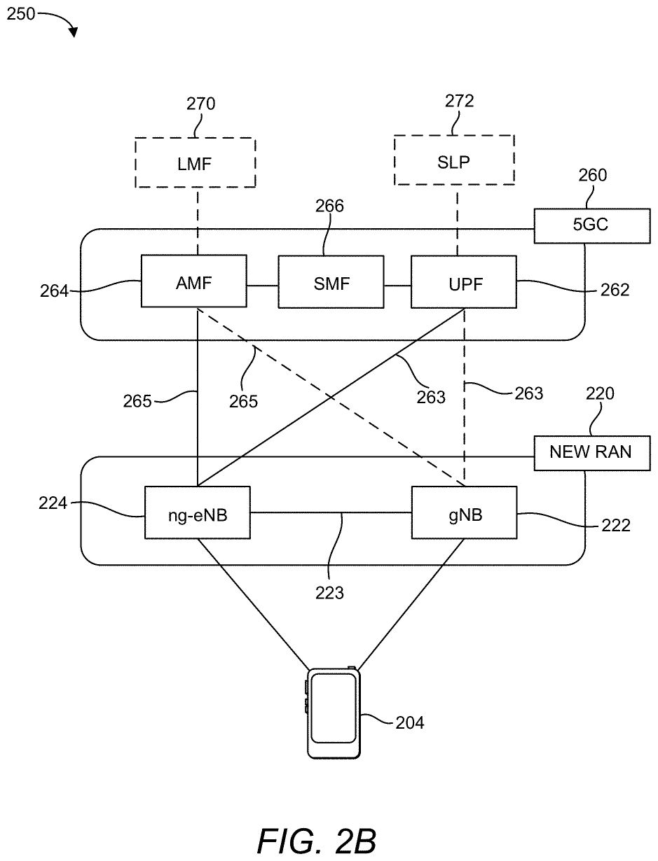

FIG. 2A illustrates an example wireless network structure 200. For example, a 5GC 210 (also referred to as a Next Generation Core (NGC)) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network.

FIG. 2B illustrates another example wireless network structure 250. For example, a 5GC 260 can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The base stations of the New RAN 220 communicate with the AMF 264 over the N2 interface and with the UPF 262 over the N3 interface.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the New RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as a secure user plane location (SUPL) location platform (SLP) 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, New RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

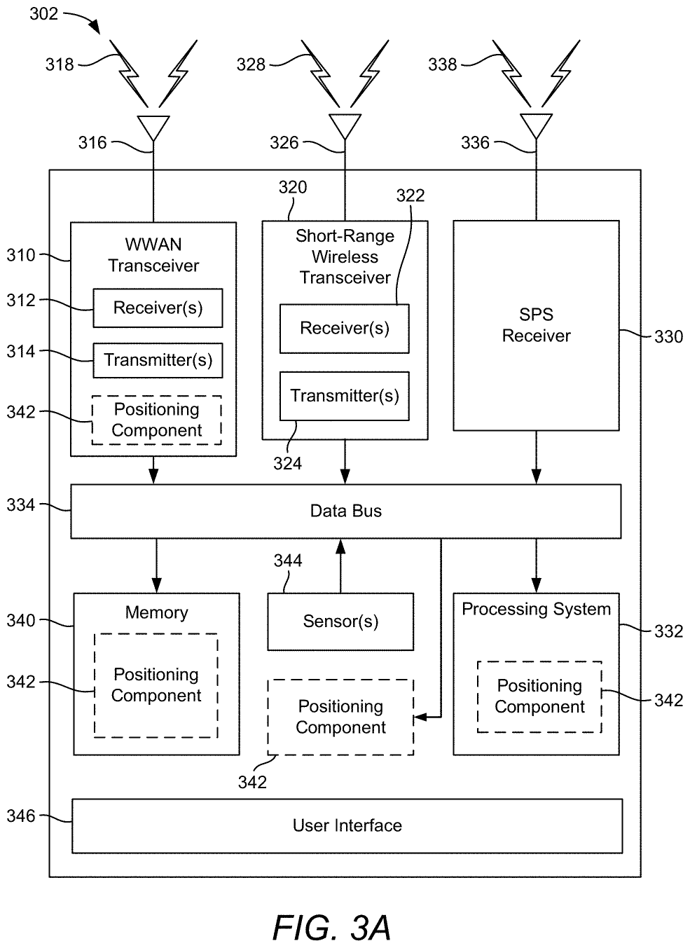

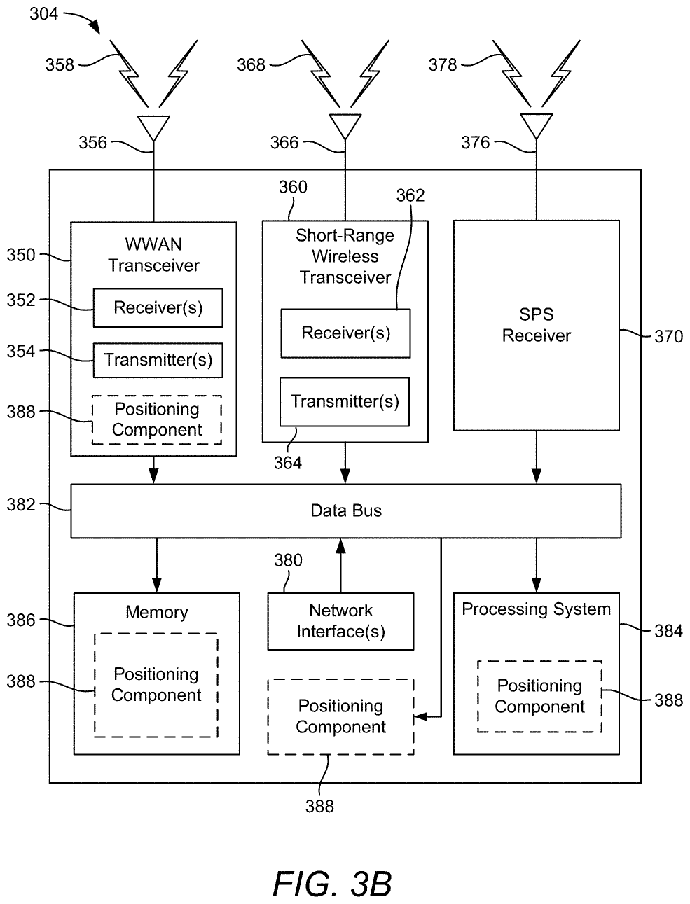

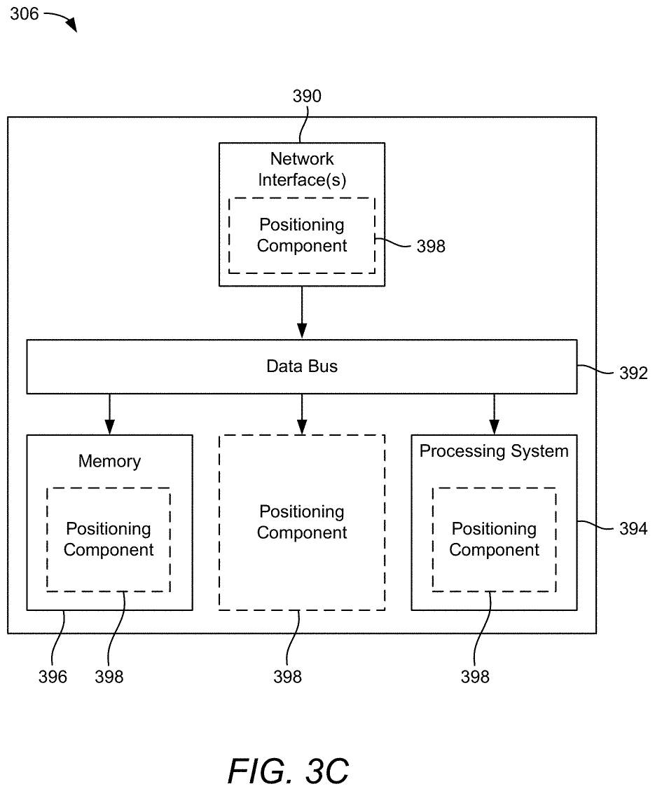

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include wireless wide area network (WWAN) transceiver 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

Transceiver circuitry including at least one transmitter and at least one receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 316, 326, 356, 366), such as an antenna array, that permits the respective apparatus to perform transmit “beamforming,” as described herein. Similarly, a receiver may include or be coupled to a plurality of antennas (e.g., antennas 316, 326, 356, 366), such as an antenna array, that permits the respective apparatus to perform receive beamforming, as described herein. In an aspect, the transmitter and receiver may share the same plurality of antennas (e.g., antennas 316, 326, 356, 366), such that the respective apparatus can only receive or transmit at a given time, not both at the same time. A wireless communication device (e.g., one or both of the transceivers 310 and 320 and/or 350 and 360) of the UE 302 and/or the base station 304 may also comprise a network listen module (NLM) or the like for performing various measurements.

The UE 302 and the base station 304 also include, at least in some cases, satellite positioning systems (SPS) receivers 330 and 370. The SPS receivers 330 and 370 may be connected to one or more antennas 336 and 376, respectively, and may provide means for receiving and/or measuring SPS signals 338 and 378, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 330 and 370 may comprise any suitable hardware and/or software for receiving and processing SPS signals 338 and 378, respectively. The SPS receivers 330 and 370 request information and operations as appropriate from the other systems, and performs calculations necessary to determine positions of the UE 302 and the base station 304 using measurements obtained by any suitable SPS algorithm.

The base station 304 and the network entity 306 each include at least one network interfaces 380 and 390, respectively, providing means for communicating (e.g., means for transmitting, means for receiving, etc.) with other network entities. For example, the network interfaces 380 and 390 (e.g., one or more network access ports) may be configured to communicate with one or more network entities via a wire-based or wireless backhaul connection. In some aspects, the network interfaces 380 and 390 may be implemented as transceivers configured to support wire-based or wireless signal communication. This communication may involve, for example, sending and receiving messages, parameters, and/or other types of information.

The UE 302, the base station 304, and the network entity 306 also include other components that may be used in conjunction with the operations as disclosed herein. The UE 302 includes processor circuitry implementing a processing system 332 for providing functionality relating to, for example, wireless positioning, and for providing other processing functionality. The base station 304 includes a processing system 384 for providing functionality relating to, for example, wireless positioning as disclosed herein, and for providing other processing functionality. The network entity 306 includes a processing system 394 for providing functionality relating to, for example, wireless positioning as disclosed herein, and for providing other processing functionality. The processing systems 332, 384, and 394 may therefore provide means for processing, such as means for determining, means for calculating, means for receiving, means for transmitting, means for indicating, etc. In an aspect, the processing systems 332, 384, and 394 may include, for example, one or more processors, such as one or more general purpose processors, multi-core processors, ASICs, digital signal processors (DSPs), field programmable gate arrays (FPGA), other programmable logic devices or processing circuitry, or various combinations thereof.

The UE 302, the base station 304, and the network entity 306 include memory circuitry implementing memory components 340, 386, and 396 (e.g., each including a memory device), respectively, for maintaining information (e.g., information indicative of reserved resources, thresholds, parameters, and so on). The memory components 340, 386, and 396 may therefore provide means for storing, means for retrieving, means for maintaining, etc. In some cases, the UE 302, the base station 304, and the network entity 306 may include positioning components 342, 388, and 398, respectively. The positioning components 342, 388, and 398 may be hardware circuits that are part of or coupled to the processing systems 332, 384, and 394, respectively, that, when executed, cause the UE 302, the base station 304, and the network entity 306 to perform the functionality described herein. In other aspects, the positioning components 342, 388, and 398 may be external to the processing systems 332, 384, and 394 (e.g., part of a modem processing system, integrated with another processing system, etc.). Alternatively, the positioning components 342, 388, and 398 may be memory modules stored in the memory components 340, 386, and 396, respectively, that, when executed by the processing systems 332, 384, and 394 (or a modem processing system, another processing system, etc.), cause the UE 302, the base station 304, and the network entity 306 to perform the functionality described herein. FIG. 3A illustrates possible locations of the positioning component 342, which may be part of the WWAN transceiver 310, the memory component 340, the processing system 332, or any combination thereof, or may be a standalone component. FIG. 3B illustrates possible locations of the positioning component 388, which may be part of the WWAN transceiver 350, the memory component 386, the processing system 384, or any combination thereof, or may be a standalone component. FIG. 3C illustrates possible locations of the positioning component 398, which may be part of the network interface(s) 390, the memory component 396, the processing system 394, or any combination thereof, or may be a standalone component.

The UE 302 may include one or more sensors 344 coupled to the processing system 332 to provide means for sensing or detecting movement and/or orientation information that is independent of motion data derived from signals received by the WWAN transceiver 310, the short-range wireless transceiver 320, and/or the SPS receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in 2D and/or 3D coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the processing system 384 in more detail, in the downlink, IP packets from the network entity 306 may be provided to the processing system 384. The processing system 384 may implement functionality for an RRC layer, a packet data convergence protocol (PDCP) layer, a radio link control (RLC) layer, and a medium access control (MAC) layer. The processing system 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the processing system 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the processing system 332, which implements Layer-3 (L3) and Layer-2 (L2) functionality.

In the uplink, the processing system 332 provides demultiplexing between transport and logical channels, packet reassembly, deciphering, header decompression, and control signal processing to recover IP packets from the core network. The processing system 332 is also responsible for error detection.

Similar to the functionality described in connection with the downlink transmission by the base station 304, the processing system 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the processing system 384.

In the uplink, the processing system 384 provides demultiplexing between transport and logical channels, packet reassembly, deciphering, header decompression, control signal processing to recover IP packets from the UE 302. IP packets from the processing system 384 may be provided to the core network. The processing system 384 is also responsible for error detection.

For convenience, the UE 302, the base station 304, and/or the network entity 306 are shown in FIGS. 3A-C as including various components that may be configured according to the various examples described herein. It will be appreciated, however, that the illustrated blocks may have different functionality in different designs.

The various components of the UE 302, the base station 304, and the network entity 306 may communicate with each other over data buses 334, 382, and 392, respectively. The components of FIGS. 3A-C may be implemented in various ways. In some implementations, the components of FIGS. 3A-C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processing systems 332, 384, 394, the transceivers 310, 320, 350, and 360, the memory components 340, 386, and 396, the positioning components 342, 388, and 398, etc.

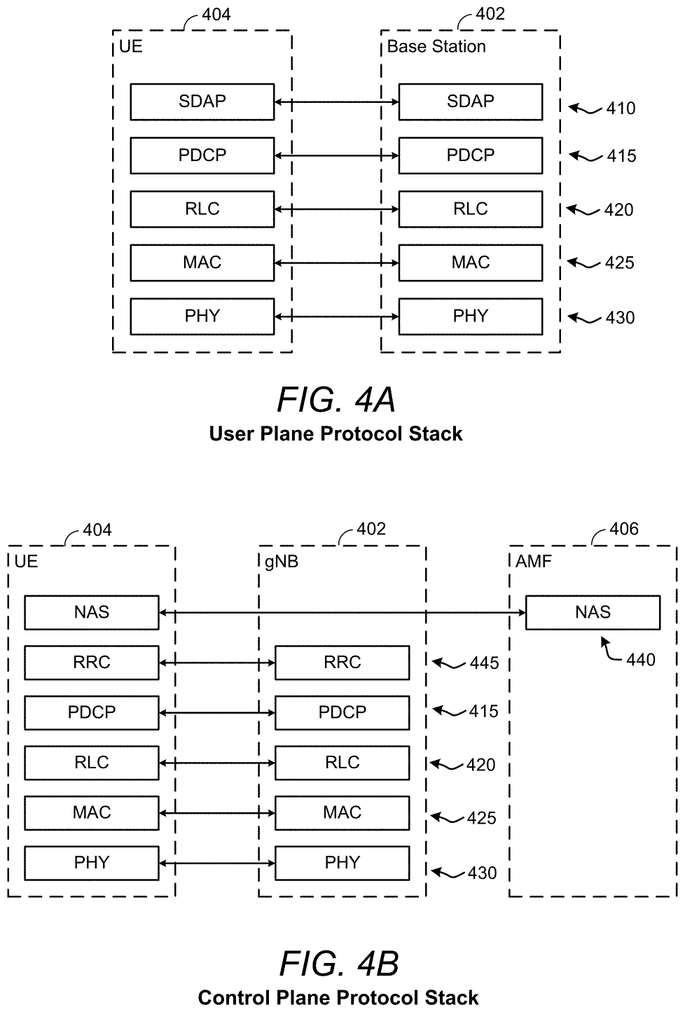

FIG. 4A illustrates a user plane protocol stack, according to aspects of the disclosure. As illustrated in FIG. 4A, a UE 404 and a base station 402 (which may correspond to any of the UEs and base stations, respectively, described herein) implement, from highest layer to lowest, a service data adaptation protocol (SDAP) layer 410, a packet data convergence protocol (PDCP) layer 415, a radio link control (RLC) layer 420, a medium access control (MAC) layer 425, and a physical (PHY) layer 430. Particular instances of a protocol layer are referred to as protocol “entities.” As such, the terms “protocol layer” and “protocol entity” may be used interchangeably.

As illustrated by the double-arrow lines in FIG. 4A, each layer of the protocol stack implemented by the UE 404 communicates with the same layer of the base station 402, and vice versa. The two corresponding protocol layers/entities of the UE 404 and the base station 402 are referred to as “peers,” “peer entities,” and the like. Collectively, the SDAP layer 410, the PDCP layer 415, the RLC layer 420, and the MAC layer 425 are referred to as “Layer 2” or “L2.” The PHY layer 430 is referred to as “Layer 1” or “L1.”

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., PRS, TRS, CSI-RS, SSB, etc.) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity can estimate the UE's location.

For DL-AoD positioning, the positioning entity uses a beam report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., SRS) transmitted by the UE. For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT”). In an RTT procedure, an initiator (a base station or a UE) transmits an RTT measurement signal (e.g., a PRS or SRS) to a responder (a UE or base station), which transmits an RTT response signal (e.g., an SRS or PRS) back to the initiator. The RTT response signal includes the difference between the ToA of the RTT measurement signal and the transmission time of the RTT response signal, referred to as the reception-to-transmission (Rx-Tx) time difference. The initiator calculates the difference between the transmission time of the RTT measurement signal and the ToA of the RTT response signal, referred to as the transmission-to-reception (Tx-Rx) time difference. The propagation time (also referred to as the “time of flight”) between the initiator and the responder can be calculated from the Tx-Rx and Rx-Tx time differences. Based on the propagation time and the known speed of light, the distance between the initiator and the responder can be determined. For multi-RTT positioning, a UE performs an RTT procedure with multiple base stations to enable its location to be triangulated based on the known locations of the base stations. RTT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). in some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

FIG. 4B illustrates a control plane protocol stack, according to aspects of the disclosure. In addition to the PDCP layer 415, the RLC layer 420, the MAC layer 425, and the PHY layer 430, the UE 404 and the base station 402 also implement a radio resource control (RRC) layer 445. Further, the UE 404 and an AMF 406 implement a non-access stratum (NAS) layer 440.

The RLC layer 420 supports three transmission modes for packets: transparent mode (TM), unacknowledged mode (UM), and acknowledged mode (AM). In TM mode, there is no RLC header, no segmentation/reassembly, and no feedback (i.e., no acknowledgment (ACK) or negative acknowledgment (NACK)). In addition, there is buffering at the transmitter only. In UM mode, there is an RLC header, buffering at both the transmitter and the receiver, and segmentation/reassembly, but no feedback (i.e., a data transmission does not require any reception response (e.g., ACK/NACK) from the receiver). In AM mode, there is an RLC header, buffering at both the transmitter and the receiver, segmentation/reassembly, and feedback (i.e., a data transmission requires a reception response (e.g., ACK/NACK) from the receiver). Each of these modes can be used to both transmit and receive data. In TM and UM modes, a separate RLC entity is used for transmission and reception, whereas in AM mode, a single RLC entity performs both transmission and reception. Note that each logical channel uses a specific RLC mode. That is, the RLC configuration is per logical channel with no dependency on numerologies and/or transmission time interval (TTI) duration (i.e., the duration of a transmission on the radio link). Specifically, the broadcast control channel (BCCH), paging control channel (PCCH), and common control channel (CCCH) use TM mode only, the dedicated control channel (DCCH) uses AM mode only, and the dedicated traffic channel (DTCH) uses UM or AM mode. Whether the DTCH uses UM or AM is determined by RRC messaging.

The main services and functions of the RLC layer 420 depend on the transmission mode and include transfer of upper layer protocol data units (PDUs), sequence numbering independent of the one in the PDCP layer 415, error correction through automatic repeat request (ARQ), segmentation and re-segmentation, reassembly of service data units (SDUs), RLC SDU discard, and RLC re-establishment. The ARQ functionality provides error correction in AM mode, and has the following characteristics: ARQ retransmissions of RLC PDUs or RLC PDU segments based on RLC status reports, polling for an RLC status report when needed by RLC, and RLC receiver triggering of an RLC status report after detection of a missing RLC PDU or RLC PDU segment.

The main services and functions of the PDCP layer 415 for the user plane include sequence numbering, header compression and decompression (for robust header compression (ROHC)), transfer of user data, reordering and duplicate detection (if in-order delivery to layers above the PDCP layer 415 is required), PDCP PDU routing (in case of split bearers), retransmission of PDCP SDUs, ciphering and deciphering, PDCP SDU discard, PDCP re-establishment and data recovery for RLC AM, and duplication of PDCP PDUs. The main services and functions of the PDCP layer 415 for the control plane include ciphering, deciphering, and integrity protection, transfer of control plane data, and duplication of PDCP PDUs.

The SDAP layer 410 is an access stratum (AS) layer, the main services and functions of which include mapping between a quality of service (QoS) flow and a data radio bearer and marking QoS flow identifier in both downlink and uplink packets. A single protocol entity of SDAP is configured for each individual PDU session.

The main services and functions of the RRC layer 445 include broadcast of system information related to AS and NAS, paging initiated by the 5GC (e.g., NGC 210 or 260) or RAN (e.g., New RAN 220), establishment, maintenance, and release of an RRC connection between the UE and RAN, security functions including key management, establishment, configuration, maintenance, and release of signaling radio bearers (SRBs) and data radio bearers (DRBs), mobility functions (including handover, UE cell selection and reselection and control of cell selection and reselection, context transfer at handover), QoS management functions, UE measurement reporting and control of the reporting, and NAS message transfer to/from the NAS from/to the UE.

The NAS layer 440 is the highest stratum of the control plane between the UE 404 and the AMF 406 at the radio interface. The main functions of the protocols that are part of the NAS layer 440 are the support of mobility of the UE 404 and the support of session management procedures to establish and maintain Internet protocol (IP) connectivity between the UE 404 and the packet data network (PDN). The NAS layer 440 performs evolved packet system (EPS) bearer management, authentication, EPS connection management (ECM)-IDLE mobility handling, paging origination in ECM-IDLE, and security control.

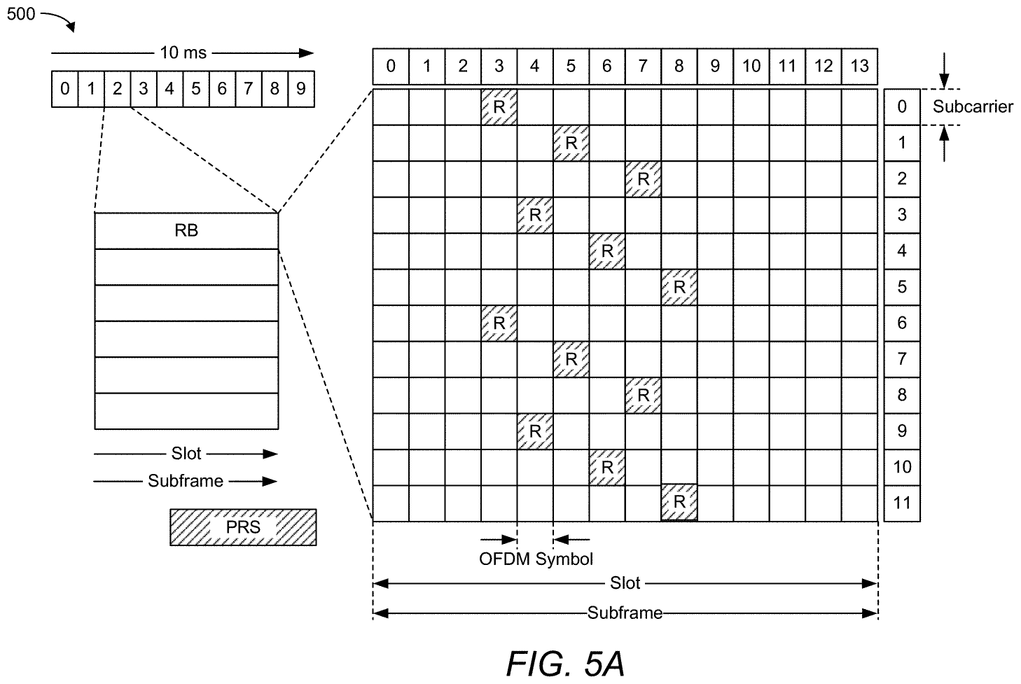

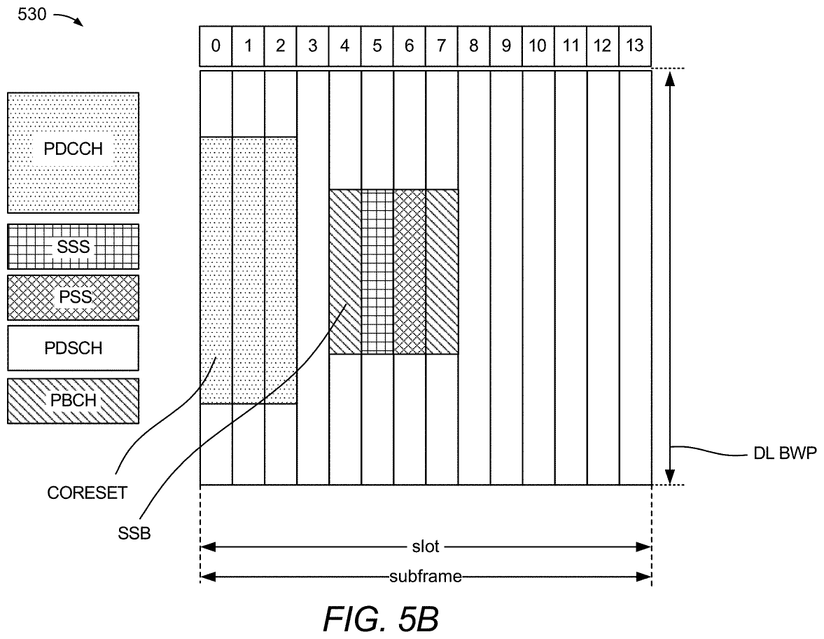

Various frame structures may be used to support downlink and uplink transmissions between network nodes (e.g., base stations and UEs). FIG. 5A is a diagram 500 illustrating an example of a downlink frame structure, according to aspects of the disclosure. FIG. 5B is a diagram 530 illustrating an example of channels within the downlink frame structure, according to aspects of the disclosure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIGS. 5A and 5B, a numerology of 15 kHz is used. Thus, in the time domain, a 10 ms frame is divided into 10 equally sized subframes of 1 ms each, and each subframe includes one time slot. In FIGS. 5A and 5B, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIGS. 5A and 5B, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs carry downlink reference (pilot) signals (DL-RS). The DL-RS may include PRS, TRS, PTRS, CRS, CSI-RS, DMRS, PSS, SSS, SSB, etc. FIG. 5A illustrates example locations of REs carrying PRS (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 5A illustrates an example PRS resource configuration for comb-6 (which spans six symbols). That is, the locations of the shaded REs (labeled “R”) indicate a comb-6 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3}; 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{014, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the PDSCH are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

FIG. 5B illustrates an example of various channels within a downlink slot of a radio frame. In NR, the channel bandwidth, or system bandwidth, is divided into multiple BWPs. A BWP is a contiguous set of PRBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5B, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries an MIB, may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5B, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5B is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., PUSCH). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

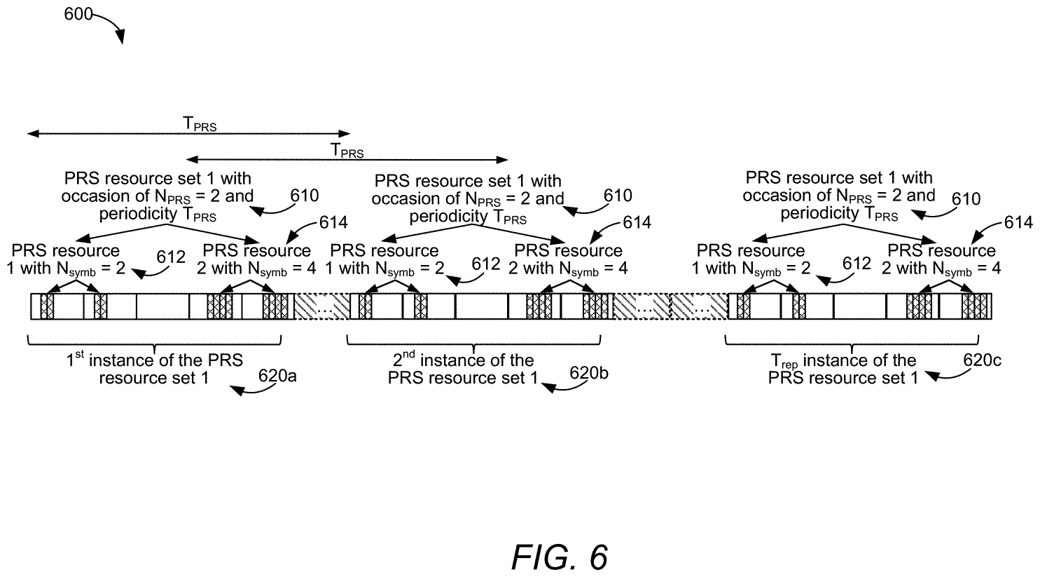

FIG. 6 is a diagram of an example PRS configuration 600 for the PRS transmissions of a given base station, according to aspects of the disclosure. In FIG. 6, time is represented horizontally, increasing from left to right. Each long rectangle represents a slot and each short (shaded) rectangle represents an OFDM symbol. In the example of FIG. 6, a PRS resource set 610 (labeled “PRS resource set 1”) includes two PRS resources, a first PRS resource 612 (labeled “PRS resource 1”) and a second PRS resource 514 (labeled “PRS resource 2”). The base station transmits PRS on the PRS resources 612 and 614 of the PRS resource set 610.

The PRS resource set 610 has an occasion length (N_PRS) of two slots and a periodicity (T_PRS) of, for example, 160 slots or 160 milliseconds (ms) (for 15 kHz subcarrier spacing). As such, both the PRS resources 612 and 614 are two consecutive slots in length and repeat every T_PRS slots, starting from the slot in which the first symbol of the respective PRS resource occurs. In the example of FIG. 6, the PRS resource 612 has a symbol length (N_symb) of two symbols, and the PRS resource 614 has a symbol length (N_symb) of four symbols. The PRS resource 612 and the PRS resource 614 may be transmitted on separate beams of the same base station.

Each instance of the PRS resource set 610, illustrated as instances 620a, 620b, and 620c, includes an occasion of length ‘2’ (i.e., N_PRS=2) for each PRS resource 612, 614 of the PRS resource set. The PRS resources 612 and 614 are repeated every T_PRS slots up to the muting sequence periodicity T_REP. As such, a bitmap of length T_REP would be needed to indicate which occasions of instances 620a, 620b, and 620c of PRS resource set 610 are muted (i.e., not transmitted).

In an aspect, there may be additional constraints on the PRS configuration 600. For example, for all PRS resources (e.g., PRS resources 612, 614) of a PRS resource set (e.g., PRS resource set 610), the base station can configure the following parameters to be the same: (a) the occasion length (T_PRS), (b) the number of symbols (N_symb), (c) the comb type, and/or (d) the bandwidth. In addition, for all PRS resources of all PRS resource sets, the subcarrier spacing and the cyclic prefix can be configured to be the same for one base station or for all base stations. Whether it is for one base station or all base stations may depend on the UE's capability to support the first and/or second option.

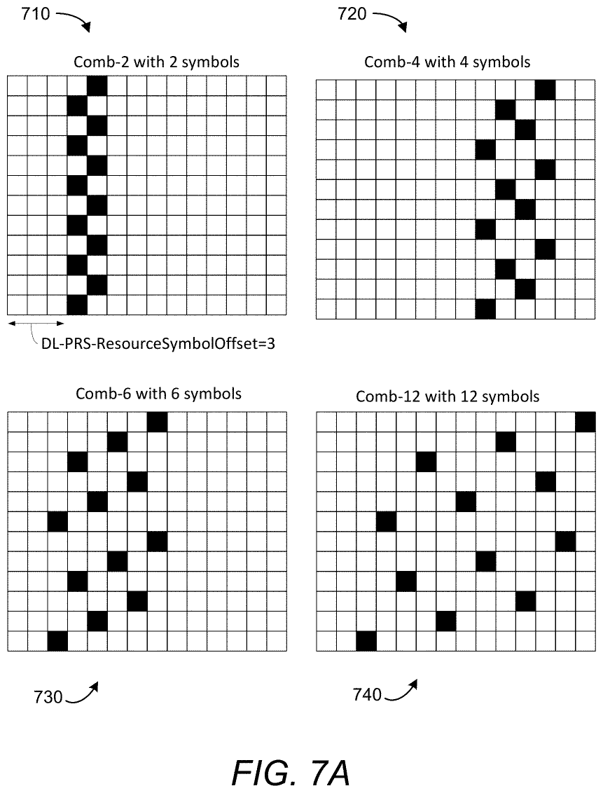

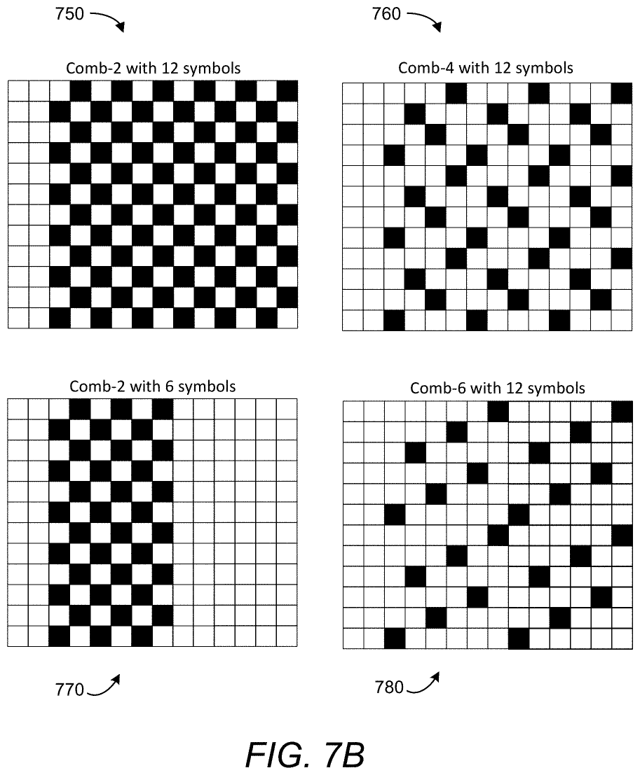

FIGS. 7A and 7B illustrate various comb patterns supported for DL-PRS within a resource block. In FIGS. 7A and 7B, time is represented horizontally and frequency is represented vertically. Each large block in FIGS. 7A and 7B represents a resource block and each small block represents a resource element. As discussed above, a resource element consists of one symbol in the time domain and one subcarrier in the frequency domain. In the example of FIGS. 7A and 7B, each resource block comprises 14 symbols in the time domain and 12 subcarriers in the frequency domain. The shaded resource elements carry, or are scheduled to carry, DL-PRS. As such, the shaded resource elements in each resource block correspond to a PRS resource, or the portion of the PRS resource within one resource block (since a PRS resource can span multiple resource blocks in the frequency domain).

The illustrated comb patterns correspond to various DL-PRS comb patterns described above. Specifically, FIG. 7A illustrates a DL-PRS comb pattern 710 for comb-2 with two symbols, a DL-PRS comb pattern 720 for comb-4 with four symbols, a DL-PRS comb pattern 730 for comb-6 with six symbols, and a DL-PRS comb pattern 740 for comb-12 with 12 symbols. FIG. 7B illustrates a DL-PRS comb pattern 750 for comb-2 with 12 symbols, a DL-PRS comb pattern 760 for comb-4 with 12 symbols, a DL-PRS comb pattern 770 for comb-2 with six symbols, and a DL-PRS comb pattern 780 for comb-6 with 12 symbols.

Note that in the example comb patterns of FIG. 7A, the resource elements on which the DL-PRS are transmitted are staggered in the frequency domain such that there is only one such resource element per subcarrier over the configured number of symbols. For example, for DL-PRS comb pattern 720, there is only one resource element per subcarrier over the four symbols. This is referred to as “frequency domain staggering.”

Further, there is some DL-PRS resource symbol offset (given by the parameter “DL-PRS-ResourceSymbolOffset”) from the first symbol of a resource block to the first symbol of the DL-PRS resource. In the example of DL-PRS comb pattern 710, the offset is three symbols. In the example of DL-PRS comb pattern 720, the offset is eight symbols. In the examples of DL-PRS comb patterns 730 and 740, the offset is two symbols. In the examples of DL-PRS comb pattern 750 to 780, the offset is two symbols.

As will be appreciated, a UE would need to have higher capabilities to measure the DL-PRS comb pattern 710 than to measure the DL-PRS comb pattern 720, as the UE would have to measure resource elements on twice as many subcarriers per symbol for DL-PRS comb pattern 710 as for DL-PRS comb pattern 720. In addition, a UE would need to have higher capabilities to measure the DL-PRS comb pattern 730 than to measure the DL-PRS comb pattern 740, as the UE will have to measure resource elements on twice as many subcarriers per symbol for DL-PRS comb pattern 730 as for DL-PRS comb pattern 740. Further, the UE would need to have higher capabilities to measure the DL-PRS comb patterns 710 and 720 than to measure the DL-PRS comb patterns 730 and 740, as the resource elements of DL-PRS comb patterns 710 and 720 are denser than the resource elements of DL-PRS comb patterns 730 and 740.

In order to establish uplink synchronization and a radio resource control (RRC) connection with a base station (or more specifically, a serving cell/TRP), a UE needs to perform a random access procedure (also referred to as a random access channel (RACH) procedure or a physical random access channel (PRACH) procedure). There are two types of random access available in NR, contention based random access (CBRA), also referred to as “four-step” random access, and contention free random access (CFRA), also referred to as “three-step” random access. There is also a “two-step” random access procedure that may be performed instead of the four-step random access procedure in certain cases.

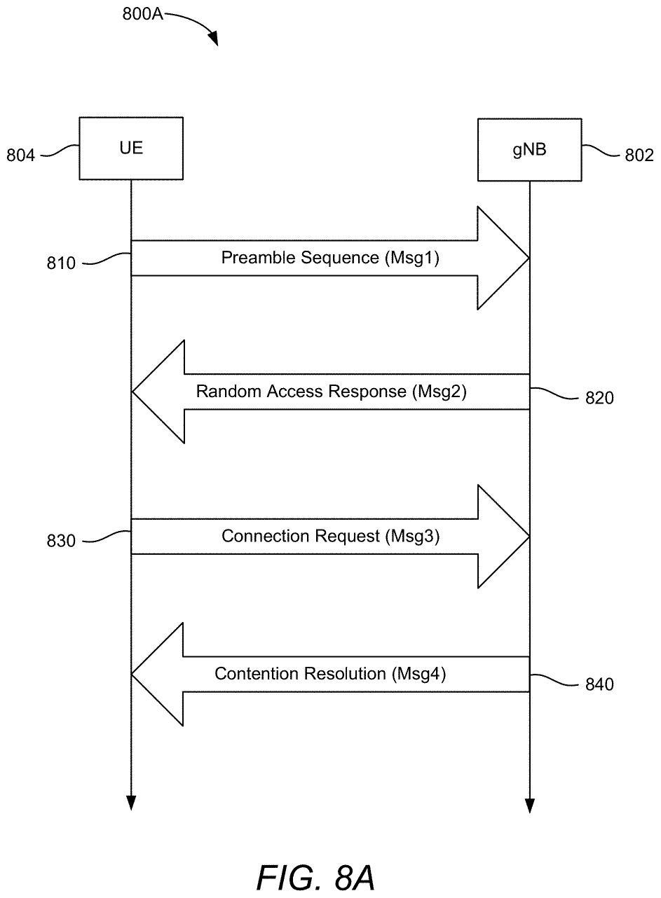

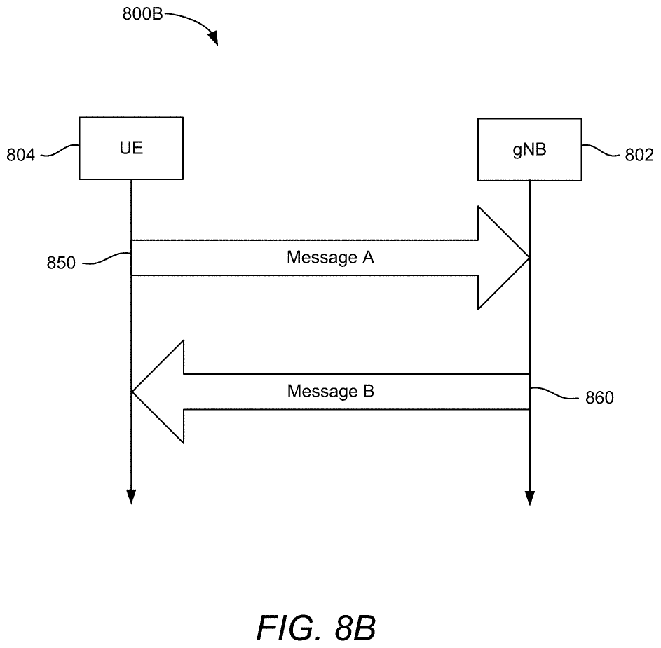

FIG. 8A illustrates an example four-step random access procedure 800A, according to aspects of the disclosure. The four-step random access procedure 800A is performed between a UE 804 and a base station 802 (illustrated as a gNB), which may correspond to any of the UEs and base stations, respectively, described herein.

There are various situations in which a UE 804 may perform the four-step random access procedure 800A. For example, a UE 804 may perform the four-step random access procedure 800A when performing an initial RRC connection setup (i.e., acquiring initial network access after coming out of the RRC IDLE state), when performing an RRC connection re-establishment procedure, when the UE 804 has uplink data to transmit, when the UE 804 has uplink data to transmit and the UE 804 is in an RRC CONNECTED state but there are no physical uplink control channel (PUCCH) resources available for a scheduling request (SR), or when there is a scheduling request failure.

Before performing the four-step random access procedure 800A, the UE 804 reads one or more synchronization signal blocks (SSBs) broadcasted by the base station 802 with which the UE 804 is performing the four-step random access procedure 800A. In NR, each beam transmitted by a base station (e.g., base station 802) is associated with a different SSB, and a UE (e.g., UE 804) selects a certain beam to use to communicate with the base station 802. Based on the SSB of the selected beam, the UE 804 can then read the system information block (SIB) type 1 (SIB1), which carries cell access related information and supplies the UE 804 with the scheduling of other system information blocks transmitted on the selected beam.

When the UE 804 sends the very first message of the four-step random access procedure 800A to the base station 802, it sends a specific pattern called a “preamble” (also referred to as a “RACH preamble,” a “PRACH preamble,” a “sequence”). The preamble differentiates requests from different UEs 804. In CBRA, a UE 804 selects a preamble randomly from a pool of preambles (64 in NR) shared with other UEs 804. However, if two UEs 804 use the same preamble at the same time, then there can be a collision, or contention.

Thus, at 810, the UE 804 selects one of the 64 preambles to send to the base station 802 as a RACH request (also referred to as a “random access request”). This message is referred to as “Message 1” or “Msg1” in a four-step random access procedure 800A. Based on the synchronization information from the base station 802 (e.g., the SIB1), the UE 804 sends the preamble at the RACH occasion (RO) corresponding to the selected SSB/beam. More specifically, in order for the base station 802 to determine which beam the UE 804 has selected, a specific mapping is defined between an SSB and an RO (which occur every 10, 20, 40, 80, or 160 ms). By detecting at which RO the UE 804 sent the preamble, the base station 802 can determine which SSB/beam the UE 804 selected.

Note that an RO is a time-frequency transmission opportunity for transmitting a preamble, and a preamble index (i.e., a value from 0 to 63 for the 64 possible preambles) enables the UE 804 to generate the type of preamble expected at the base station 802. The RO and preamble index may be configured to the UE 804 by the base station 802 in a SIB. A RACH resource is an RO in which one preamble index is transmitted. As such, the terms “RO” (or “RACH occasion”) and “RACH resource” may be used interchangeably, depending on the context.

Due to reciprocity, the UE 804 may use the uplink transmit beam corresponding to the best downlink receive beam determined during synchronization (i.e., the best receive beam to receive the selected downlink beam from the base station 802). That is, the UE 804 uses the parameters of the downlink receive beam used to receive the SSB beam from the base station 802 to determine the parameters of the uplink transmit beam. If reciprocity is available at the base station 802, the UE 804 can transmit the preamble over one beam. Otherwise, the UE 804 repeats transmission of the same preamble on all of its uplink transmit beams.

The UE 804 also needs to provide its identity to the network (via base station 802) so that the network can address it in the next step. This identity is called the random access radio network temporary identity (RA-RNTI) and is determined from the time slot in which the preamble is sent.

If the UE 804 does not receive a response from the base station 802 within some period of time, it increases its transmission power by a fixed step and sends the preamble/Msg1 again. More specifically, the UE 804 transmits a first set of repetitions of the preamble, then, if it does not receive a response, it increases its transmission power and transmits a second set of repetitions of the preamble. The UE 804 continues increasing its transmit power in incremental steps until it receives a response from the base station 802.

At 820, the base station 802 sends a random access response (RAR), referred to as a “Message 2” or “Msg2” in a four-step random access procedure 800A, to the UE 804 on the selected beam. The RAR is sent on a physical downlink shared channel (PDSCH) and is addressed to the RA-RNTI calculated from the time slot (i.e., RO) in which the preamble was sent. The RAR carries the following information: a cell-radio network temporary identifier (C-RNTI), a timing advance (TA) value, and an uplink grant resource. The base station 802 assigns the C-RNTI to the UE 804 to enable further communication with the UE 804. The TA value specifies how much the UE 804 should change its timing to compensate for the propagation delay between the UE 804 and the base station 802. The uplink grant resource indicates the initial resources the UE 804 can use on the physical uplink shared channel (PUSCH). After this step, the UE 804 and the base station 802 establish coarse beam alignment that can be utilized in the subsequent steps.

At 830, using the allocated PUSCH, the UE 804 sends an RRC connection request message, referred to as a “Message 3” or “Msg3,” to the base station 802. Because the UE 804 sends the Msg3 over the resources scheduled by the base station 802, the base station 802 knows from where (spatially) to detect the Msg3 and therefore which uplink receive beam should be used. Note that the Msg3 PUSCH can be sent on the same or different uplink transmit beam as the Msg1.

The UE 804 identifies itself in the Msg3 by the C-RNTI assigned in the previous step. The message contains the UE's 804 identity and connection establishment cause. The UE's 804 identity is either a temporary mobile subscriber identity (TMSI) or a random value. A TMSI is used if the UE 804 has previously connected to the same network. The UE 804 is identified in the core network by the TMSI. A random value is used if the UE 804 is connecting to the network for the very first time. The reason for the random value or TMSI is that the C-RNTI may have been assigned to more than one UE 804 in the previous step, due to multiple requests arriving at the same time. The connection establishment cause indicates the reason why the UE 804 needs to connect to the network (e.g., for a positioning session, because it has uplink data to transmit, because it received a page from the network, etc.).

As noted above, the four-step random access procedure 800A is a CBRA procedure. Thus, as described above, any UE 804 connecting to the same base station 802 can send the same preamble at 810, in which case, there is a possibility of collision, or contention, among the requests from the various UEs 804. Accordingly, the base station 802 uses a contention resolution mechanism to handle this type of access request. In this procedure, however, the result is random and not all random access succeeds.

Thus, at 840, if the Msg3 was successfully received, the base station 802 responds with a contention resolution message, referred to as a “Message 4” or “Msg4.” This message is addressed to the TMSI or random value (from the Msg3) but contains a new C-RNTI that will be used for further communication. Specifically, the base station 802 sends the Msg4 in the PDSCH using the downlink transmit beam determined in the previous step.

As shown in FIG. 8A, the four-step random-access procedure 800A requires two round-trip cycles between the UE 804 and the base station 802, which not only increases latency but also incurs additional control signaling overhead. To address these issues, two-step random access has been introduced in NR for CBRA. The motivation behind two-step random access is to reduce latency and control signaling overhead by having a single round trip cycle between a UE and a base station. This is achieved by combining the preamble (Msg1) and the scheduled PUSCH transmission (Msg3) into a single message from the UE to the base station, known as “MsgA.” Similarly, the random access response (Msg2) and the contention resolution message (Msg4) are combined into a single message from the base station to the UE, known as “MsgB.” This reduces latency and control signaling overhead.

FIG. 8B illustrates an example two-step random access procedure 800B, according to aspects of the disclosure. The two-step random access procedure 800B may be performed between a UE 804 and a base station 802 (illustrated as a gNB), which may correspond to any of the UEs and base stations, respectively, described herein.

At 850, the UE 804 transmits a RACH Message A (“MsgA”) to the base station 802. In a two-step random access procedure 800B, Msg1 and Msg3, described above with reference to FIG. 8A, are collapsed (i.e., combined) into a MsgA and sent to the base station 802. As such, a MsgA includes a preamble and a PUSCH similar to the Msg3 PUSCH of a four-step random access procedure 800A. The preamble may have been selected from the 64 possible preambles, as described above with reference to FIG. 8A, and may be used as a reference signal for demodulating the data transmitted in the MsgA. At 860, the UE 804 receives a RACH Message B (“MsgB”) from the base station 802. The MsgB may be a combination of Msg2 and Msg4 described above with reference to FIG. 8A.

The combination of Msg1 and Msg3 into one MsgA and the combination of Msg2 and Msg4 into one MsgB allows the UE 804 to reduce the RACH procedure setup time to support the low-latency requirements of NR. Although the UE 804 may be configured to support the two-step random access procedure 800B, the UE 804 may still support the four-step random access procedure 800A as a fall back if the UE 804 is not able to use the two-step random access procedure 800B due to some constraints (e.g., high transmit power requirements, etc.). Therefore, a UE 804 in NR may be configured to support both the four-step and the two-step random access procedures 800A and 800B, and may determine which random access procedure to use based on the RACH configuration information received from the base station 802.

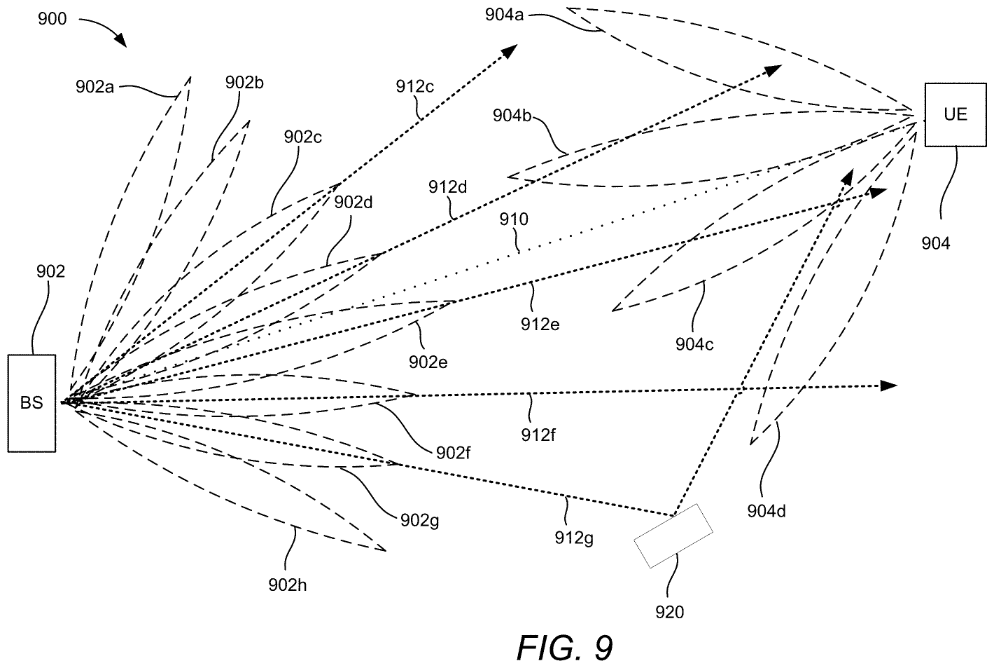

As noted above, some wireless communications networks, such as NR, may employ beamforming at mmW or near mmW frequencies to increase the network capacity. The use of mmW frequencies may be in addition to microwave frequencies (e.g., in the “sub-6” GHz, or FR1, band) that may also be supported for use in communication, such as when carrier aggregation is used. FIG. 9 is a diagram 900 illustrating a base station (BS) 902 (which may correspond to any of the base stations described herein) in communication with a UE 904 (which may correspond to any of the UEs described herein). Referring to FIG. 9, the base station 902 may transmit a beamformed signal to the UE 904 on one or more transmit beams 902a, 902b, 902c, 902d, 902e, 902f, 902g, 902h, each having a beam identifier that can be used by the UE 904 to identify the respective beam. Where the base station 902 is beamforming towards the UE 904 with a single array of antennas (e.g., a single TRP/cell), the base station 902 may perform a “beam sweep” by transmitting first beam 902a, then beam 902b, and so on until lastly transmitting beam 902h. Alternatively, the base station 902 may transmit beams 902a-902h in some pattern, such as beam 902a, then beam 902h, then beam 902b, then beam 902g, and so on. Where the base station 902 is beamforming towards the UE 904 using multiple arrays of antennas (e.g., multiple TRPs/cells), each antenna array may perform a beam sweep of a subset of the beams 902a-902h. Alternatively, each of beams 902a-902h may correspond to a single antenna or antenna array.

FIG. 9 further illustrates the paths 912c, 912d, 912e, 912f, and 912g followed by the beamformed signal transmitted on beams 902c, 902d, 902e, 902f, and 902g, respectively. Each path 912c, 912d, 912e, 912f, 912g may correspond to a single “multipath” or, due to the propagation characteristics of radio frequency (RF) signals through the environment, may be comprised of a plurality (a cluster) of “multipaths.” Note that although only the paths for beams 902c-902g are shown, this is for simplicity, and the signal transmitted on each of beams 902a-902h will follow some path. In the example shown, the paths 912c, 912d, 912e, and 912f are straight lines, while path 912g reflects off an obstacle 920 (e.g., a building, vehicle, terrain feature, etc.).

The UE 904 may receive the beamformed signal from the base station 902 on one or more receive beams 904a, 904b, 904c, 904d. Note that for simplicity, the beams illustrated in FIG. 9 represent either transmit beams or receive beams, depending on which of the base station 902 and the UE 904 is transmitting and which is receiving. Thus, the UE 904 may also transmit a beamformed signal to the base station 902 on one or more of the beams 904a-904d, and the base station 902 may receive the beamformed signal from the UE 904 on one or more of the beams 902a-902h.

In an aspect, the base station 902 and the UE 904 may perform beam training to align the transmit and receive beams of the base station 902 and the UE 904. For example, depending on environmental conditions and other factors, the base station 902 and the UE 904 may determine that the best transmit and receive beams are 902d and 904b, respectively, or beams 902e and 904c, respectively. The direction of the best transmit beam for the base station 902 may or may not be the same as the direction of the best receive beam, and likewise, the direction of the best receive beam for the UE 904 may or may not be the same as the direction of the best transmit beam.

In the example of FIG. 9, if the base station 902 transmits reference signals (e.g., PRS, CRS, TRS, CSI-RS, PSS, SSS, etc.) to the UE 904 on beams 902c, 902d, 902e, 902f, and 902g, then transmit beam 902e is best aligned with the line-of-sight (LOS) path 910, while transmit beams 902c, 902d, 902f, and 902g are not. As such, beam 902e is likely to have a higher received signal strength (e.g., RSRP, RSRQ, SINR, etc.) at the UE 904 than beams 902c, 902d, 902f, and 902g. Similarly, the channel energy response (CER), or channel impulse response (CIR), will be stronger for transmit beams that are closer to the LOS path 910 than for transmit beams that are further from the LOS path 910. Note that the reference signals transmitted on some beams (e.g., beams 902c and/or 9020 may not reach the UE 904, or energy reaching the UE 904 from these beams may be so low that the energy may not be detectable or at least can be ignored.

Note that while the UE 904 is illustrated as being capable of beamforming, this is not necessary. Rather, the UE 904 may receive and transmit on an omni-directional antenna.

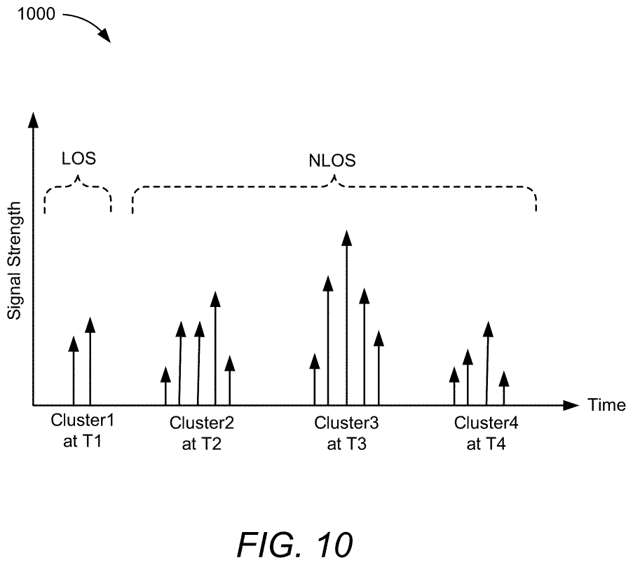

FIG. 10 is a graph 1000 illustrating the channel impulse response of a multipath channel between a receiver device (e.g., any of the UEs or base stations described herein) and a transmitter device (e.g., any other of the UEs or base stations described herein), according to aspects of the disclosure. The channel impulse response represents the intensity of a radio frequency (RF) signal received through a multipath channel as a function of time delay. Thus, the horizontal axis is in units of time (e.g., milliseconds) and the vertical axis is in units of signal strength (e.g., decibels). Note that a multipath channel is a channel between a transmitter and a receiver over which an RF signal follows multiple paths, or multipaths, due to transmission of the RF signal on multiple beams and/or to the propagation characteristics of the RF signal (e.g., reflection, refraction, etc.).

In the example of FIG. 10, the receiver detects/measures multiple (four) clusters of channel taps. Each channel tap represents a multipath that an RF signal followed between the transmitter and the receiver. That is, a channel tap represents the arrival of an RF signal on a multipath. Each cluster of channel taps indicates that the corresponding multipaths followed essentially the same path. There may be different clusters due to the RF signal being transmitted on different transmit beams (and therefore at different angles), or because of the propagation characteristics of RF signals (e.g., potentially following different paths due to reflections), or both.

All of the clusters of channel taps for a given RF signal represent the multipath channel (or simply channel) between the transmitter and receiver. Under the channel illustrated in FIG. 10, the receiver receives a first cluster of two RF signals on channel taps at time T1, a second cluster of five RF signals on channel taps at time T2, a third cluster of five RF signals on channel taps at time T3, and a fourth cluster of four RF signals on channel taps at time T4. In the example of FIG. 10, because the first cluster of RF signals at time T1 arrives first, it is assumed to correspond to the RF signal transmitted on the transmit beam aligned with the LOS, or the shortest, path. The third cluster at time T3 is comprised of the strongest RF signals, and may correspond to, for example, the RF signal transmitted on a transmit beam aligned with a non-line-of-sight (NLOS) path (e.g., the path followed by beam 912g in FIG. 9). Note that although FIG. 10 illustrates clusters of two to five channel taps, as will be appreciated, the clusters may have more or fewer than the illustrated number of channel taps.

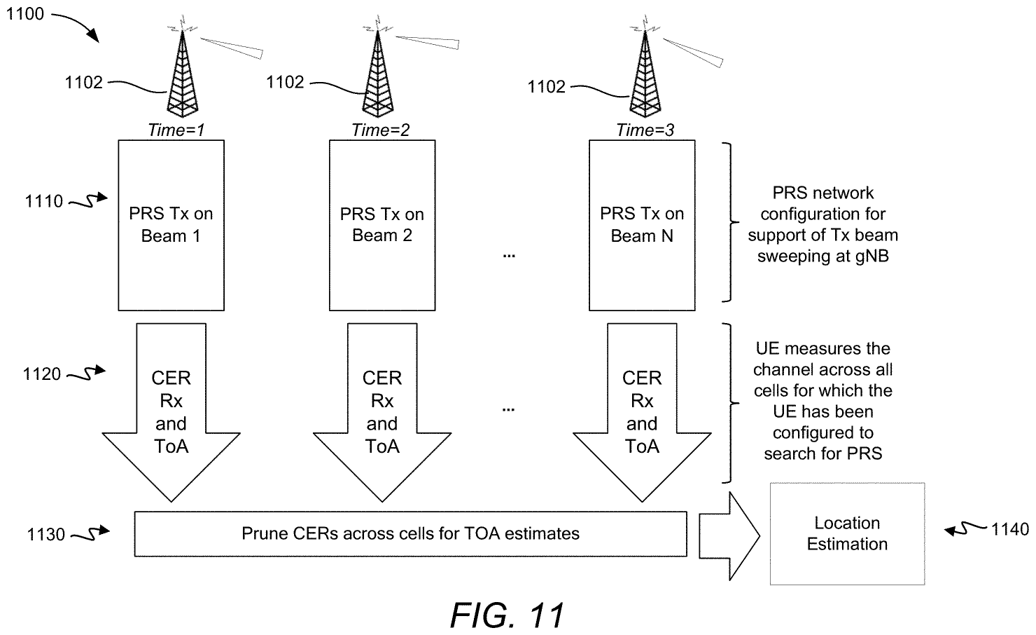

FIG. 11 is a diagram of an example physical layer procedure 1100 for processing PRS transmitted on multiple beams, according to aspects of the disclosure. At stage 1110, the network (e.g., location server 230, LMF 270, SLP 272) configures a given base station 1102 (e.g., any of the base stations described herein) to transmit (Tx) beamformed PRS to one or more UEs in the coverage area(s) of the cell(s) supported by the base station 1102. The PRS configuration may include multiple instances of PRS (e.g., as described above with reference to FIG. 6) to be beam swept (e.g., as described above with reference to FIG. 9) across all AoDs for each cell at full transmit power per beam. In the example of FIG. 11, the base station 1102 transmits PRS on a first beam (“Beam 1”) at a first time (“Time=1”), a second beam (“Beam 2”) at a second time (“Time=2”), and so on until an Nth beam (“Beam N”) at an Nth time (“Time=N”), where N is an integer from 1 to 128 (i.e., there may be as many as 128 beams for a single cell). The illustrated beams may be for a particular cell supported by the base station 1102, and the base station 1102 may beam sweep PRS in each of the cells it supports. The base station 1102 may beam sweep using a single antenna or antenna array, in which case, that antenna or antenna array transmits each beam (Beams 1 to N). Alternatively, the base station 1102 may beam sweep using multiple antennas or antenna arrays, in which case, each antenna or antenna array transmits one or more of Beams 1 to N.

At 1120, a given UE monitors all cells that it has been configured by the network to monitor and that are configured to transmit PRS across the configured instances. There may need to be several PRS instances/occasions to permit the UE to detect a sufficient number of cells for positioning (due to the time it takes the UE to tune its radio from one cell to another and then monitor the cell). The UE measures the channel, in particular, the CER and ToA, across all cells for which the UE has been configured to search for PRS.

At 1130, the UE prunes the CERs across cells to determine the ToAs of the PRS beams. At 1140, the ToAs, or other positioning measurements (e.g., Rx-Tx time difference, RSTD, RSRP, etc.), can be used to estimate the location of the UE using, for example, DL-TDOA, RTT, AoD, etc. The UE can estimate its position based on the ToAs if it has been provided with a base station almanac (BSA) of base station locations. Alternatively, the network can estimate the location of the UE if the UE reports the ToAs to the network.

Due to UE mobility/movement, beam reconfiguration at the base station, and/or other factors, a downlink beam (e.g., comprising a downlink control link), which may have been the preferred active beam, may fail to be detected at the UE, or the signal quality (e.g., RSRP, RSRQ, SINR, etc.) may fall below a threshold, causing the UE to consider it as a beam/link failure. Thus, a beam failure may refer to, for example, failure to detect a strong (e.g., with signal power greater than a threshold) active beam, which may, in some aspects, correspond to a control channel communicating control information from the network (e.g., a PDCCH). A beam recovery procedure may be employed to recover from such a beam failure.

In certain aspects, in order to facilitate beam failure detection, a UE may be preconfigured with beam identifiers (IDs) of a first set of beams (referred to as “set_q0”) to be monitored, a monitoring period, a signal strength threshold, etc. The recovery may be triggered when a signal strength (e.g., RSRP, RSRQ, SINR, etc.) associated with the one or more monitored beams (as detected by the UE) falls below a threshold. The recovery process may include the UE identifying anew preferred beam, for example, from a second set of possible beams (corresponding to beam IDs that may be included in a second set, referred to as “set_q1”), and performing a RACH procedure using preconfigured time and frequency resources corresponding to the new preferred beam. The beam IDs corresponding to the beams in the second set of beams (set_q1) may be preconfigured at the UE for use for beam failure recovery purposes. For example, the UE may monitor downlink beams (based on the beam IDs and resources identified in the second set of beams, set_q1), perform measurements, and determine (e.g., based on the measurements) which beam out of all received and measured beams may be the best for reception at the UE from the UE's perspective.

If beam correspondence is assumed (i.e., the direction of the best downlink receive beam used by the UE is also considered the best direction for the uplink transmit beam used by the UE), then the UE may assume the same beam configuration for both reception and transmission. That is, based on monitoring downlink reference signals from the base station, the UE can determine its preferred uplink transmit beam weights, which will be the same as for the downlink receive beam used for receiving the downlink reference signals.

Where beam correspondence is not assumed (e.g., deemed not suitable in the given scenario or for other reasons), the UE may not derive the uplink transmit beam from the downlink receive beam. Instead, separate signaling is needed to select the uplink transmit and downlink receive beam weights and for the uplink-to-downlink beam pairing. The UE may perform a RACH procedure (e.g., using the preconfigured time and frequency resources indicated in the second set of beams, set_q1) to identify the uplink transmit beam. Performing the RACH procedure using the preconfigured time and frequency resources may comprise, for example, transmitting a RACH preamble on one or more uplink transmit beams (corresponding to the beam IDs in the second set of beams, set_q1) on allocated RACH resources corresponding to the one or more beams. Based on the RACH procedure, the UE may be able to determine and confirm with the base station which uplink direction may be the best beam direction for an uplink channel (e.g., PUCCH). In this manner, both uplink transmit and downlink receive beams may be reestablished and beam recovery may be completed.

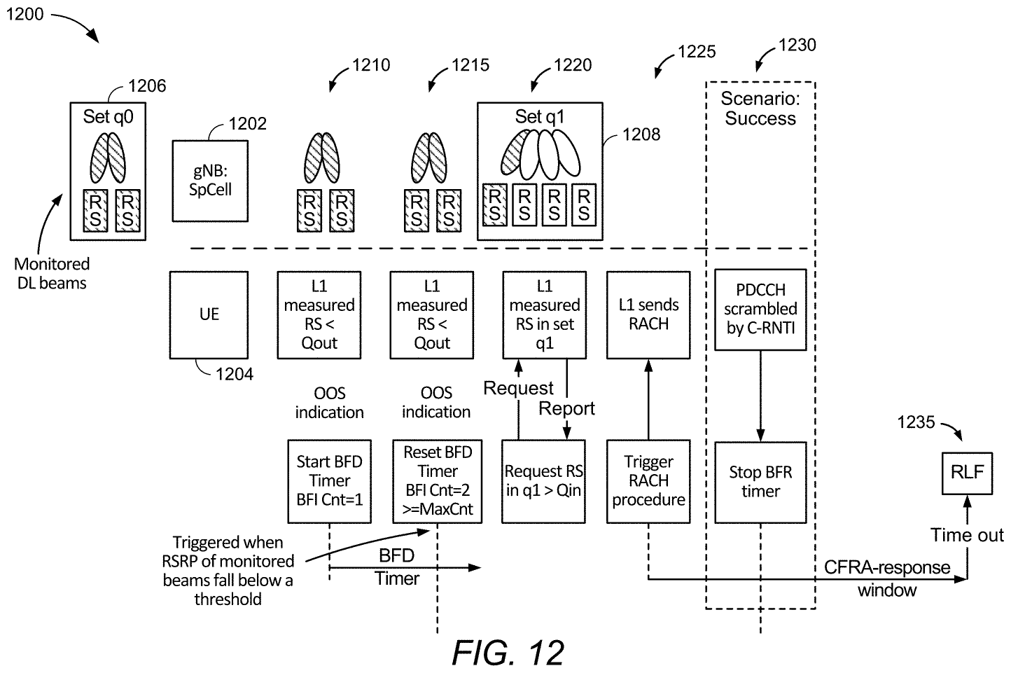

FIG. 12 is a diagram 1200 of an example RACH-based SpCell beam failure recovery procedure, according to aspects of the disclosure. In the example of FIG. 12, for simplicity, the PCell and SCell are shown to be associated with a single base station (e.g., the hardware/circuitry for implementing the PCell and SCell may be collocated at the same base station). However, in some other configurations, the PCell and SCell may be associated with different base stations that may be synchronized.

In the example of FIG. 12, a PCell or a primary (i.e., in active use) SCell (together referred to as an “SpCell”) is supported by a base station 1202 (illustrated as a “gNB,” and which may correspond to any of the base stations described herein). A UE 1204 (which may correspond to any of the UEs described herein) monitors the received signal strength (e.g., RSRP, RSRQ, SINR, etc.) of periodic reference signals (e.g., PRS) transmitted by the base station 1202 on a first set (“set_q0”) of downlink transmit beams 1206 of the SpCell. The first set of downlink transmit beams 1206 may correspond to one or more of beams 902a-h in FIG. 9 in the mmW frequency range. The first set of downlink transmit beams 1206 is referred to as the “failure detection resource set” because the base station 1202 sends the beam IDs of the beams in the first set of downlink transmit beams 1206 to the UE 1204 to enable the UE 1204 to monitor these beams to determine whether or not the downlink control link (i.e., a control channel communicating control information from the network, e.g., a PDCCH) between the base station 1202 and the UE 1204 is active. In the example of FIG. 12, the first set of downlink transmit beams 1206 includes two beams. However, as will be appreciated, there may be only one beam or more than two beams in the first set of downlink transmit beams 1206.

At 1210, the UE 1204 fails to detect a periodic reference signal transmitted on at least one of the beams in the first set of downlink transmit beams 1206, and/or detects that a quality metric (e.g., RSRP, RSRQ, SINR, etc.) associated with the reference signal has fallen below a signal quality threshold (represented in FIG. 12 as “Qout”). The Qout threshold may be configured by the base station 1202. More specifically, the Layer 1 (labeled “L1” in FIG. 12) functionality of the UE 1204 (e.g., implemented in the WWAN transceiver 310 and corresponding to the physical layer 430 in FIGS. 4A and 4B) detects that the measured quality metric of the periodic reference signal is below the Qout threshold, and sends an out-of-sync (OOS) indication to the processing system 332 (which implements the Layer 2 and Layer 3 functionality of the UE 1204). In response to receiving the OOS indication, the processing system 332 of the UE 1204 starts a beam failure detection (BFD) timer and initializes a beam failure indicator (BFI) counter to ‘1.’

At 1215, the UE 1204 again fails to detect the periodic reference signal transmitted on the at least one of the beams in the first set of downlink transmit beams 1206, and/or again detects that the quality metric associated with the reference signal has fallen below the Qout threshold. Again, more specifically, the Layer 1 functionality of the UE 1204 detects that the measured quality metric of the periodic reference signal is below the Qout threshold, and sends another OOS indication to the processing system 332. The processing system 332 increments the BFI count to ‘2.’ Because the BFI count has reached the maximum count (“MaxCnt”) threshold while the BFD timer is running, the UE 1204 determines that there has been a beam failure of the at least one beam (e.g., a downlink control beam) in the first set of downlink transmit beams 1206. Because there is a failure of a downlink control beam (corresponding to the downlink control channel communicating control information from the network), the UE 1204 assumes that there is also a failure of the corresponding uplink control beam (corresponding to the uplink control channel for communicating control information to the network, e.g., a PUCCH). As such, the UE 1204 needs to identify a new downlink control beam and re-establish an uplink control beam.

Thus, at 1220, in response to the beam failure detection at 1215, the UE 1204 initiates a beam failure recovery procedure. More specifically, the processing system 332 of the UE 1204 requests that the Layer 1 functionality of the UE 1204 identify at least one beam in a second set (“set_q1”) of downlink transmit beams 1208 that carries a periodic reference signal with a received signal strength greater than a signal quality threshold (represented as “Qin”). The second set of downlink transmit beams 1208 may correspond to one or more of beams 902a-h in FIG. 9 in the mmW frequency range. The second set of downlink transmit beams 1208 is referred to as the “candidate beam reference signal list.” The UE 1204 may receive both the beam IDs of the beams in the second set of downlink transmit beams 1208 and the Qin threshold from the base station 1202. In the example of FIG. 12, the second set of downlink transmit beams 1208 includes four beams, one of which (shaded) carries periodic reference signals having a received signal strength greater than the Qin threshold. However, as will be appreciated, there may be more or fewer than four beams in the second set of downlink transmit beams 1208, and there may be more than one beam that meets the Qin threshold. The WWAN transceiver 310 (implementing Layer 1 functionality) reports the identified candidate beam to the processing system 332. The identified candidate beam can then be used as the new downlink control beam, although not necessarily immediately.

At 1225, to re-establish an uplink control beam, the UE 1204 performs a RACH procedure on the one or more candidate downlink transmit beams identified at 1220 (one in the example of FIG. 12). More specifically, the processing system 332 instructs the WWAN transceiver 310 to send a RACH preamble (which may be pre-stored or provided to the UE 1204 by the base station 1202) to the base station 1202. The WWAN transceiver 310 sends the RACH preamble (also referred to as a Message 1 (“Msg1”)) on one or more uplink transmit beams corresponding to the one or more candidate downlink transmit beams identified at 1220 on preconfigured RACH resources for the one or more candidate uplink transmit beams. The preconfigured RACH resources may correspond to the SpCell (e.g., in the mmW band). Although not illustrated in FIG. 12, at 1225, the UE 1204 also starts a beam failure recovery (BFR) timer that defines a contention-free random access (CFRA) window.

The one or more candidate downlink transmit beams identified at 1220 can include beams that are different than the downlink transmit beam associated with the beam failure. As used herein, a “beam” is defined by beam weights associated with an antenna array of the UE 1204. Hence, in some aspects, whether used for uplink transmission by the UE 1204 or downlink reception by the UE 1204, the weights applied to each antenna element in the antenna array to construct the transmitted or received beam define the beam. As such, the one or more candidate uplink transmit beams on which the RACH preamble is sent may have different weights than the downlink transmit beam associated with the beam failure, even if such candidate uplink transmit beam is in generally a similar direction as the downlink transmit beam indicated to be failing.

At 1230, the base station 1202 transmits a RACH response (referred to as a “Msg1 response”) to the UE 1204 with a cell-radio network temporary identifier (C-RNTI) via a PDCCH associated with the SpCell. For example, the response may comprise cyclic redundancy check (CRC) bits scrambled by the C-RNTI. After the WWAN transceiver 310 of the UE 1204 processes the received response with the C-RNTI via the SpCell PDCCH from the base station 1202 and determines that the received PDCCH is addressed to the C-RNTI, the processing system 332 determines that the beam failure recovery procedure has completed and stops the BFR timer started at 1225. In an aspect, the C-RNTI may be mapped to a beam direction determined by the base station 1202 to be the best direction for an uplink channel (e.g., PUCCH) for the UE 1204. Accordingly, upon receipt of the response with C-RNTI from the base station 1202, the UE 1204 may be able to determine the optimal uplink transmit beam that is best suited for the uplink channel.

The operations at 1230 are part of a first scenario in which the UE 1204 successfully recovers from the beam failure detected at 1215. However, such a recovery may not always occur, or at least not before the BFR timer started at 1225 expires. If the BFR timer expires before the beam failure recovery procedure completes successfully, then at 1235, the UE 1204 determines that a radio link failure (RLF) has occurred.

In some cases, a location server (e.g., location server 230, LMF 270, SLP 272) may configure PRS transmitted by different base stations (or different TRPs/cells of one or more base stations) to be frequency-division multiplexed with each other to form one larger bandwidth PRS. In such a situation, the PRS transmitted by a first base station (referred to as a “component PRS”) may have a comb type of comb-2 over two symbols (e.g., DL-PRS comb pattern 710 of FIG. 7A), and the PRS transmitted by a second base station (another component PRS) may also have a comb type of comb-2. Both component PRS may begin on the same symbol of an RB, but may start on different subcarriers. For example, the first component PRS may start on subcarrier ‘0,’ and the second component PRS may start on subcarrier ‘1.’ In that way, the first and second component PRS form a contiguous block in the frequency domain, making it easier for the UE to accurately measure the combined PRS.

As described above, in mmW systems, a base station (or TRP/cell) may transmit PRS on a particular downlink transmit beam, and a UE may receive the PRS on a particular downlink receive beam. The downlink transmit beam and the downlink receive beam are referred to as a “transmit-receive beam pair,” or simply a “beam pair” or “beam pairing.” However, due to the limitation of analog beamforming, a UE may not have the capability to form more than one receive beam at a time, and therefore, may not be able to form a transmit-receive beam pair with each base station (or TRP/cell) from which it is configured to receive PRS. In the case of frequency-division multiplexing (FDM) of PRS, this is problematic, because the UE needs to receive the component PRS from the different base stations (or TRP/cell) at the same time (i.e., during the same symbol). As such, the UE will need to use the same receive beam for all base stations, even if it is not the best receive beam for all of them, or even if it cannot receive the PRS from the other base station(s) on that receive beam.

Continuing the example above, the first base station may be the UE's serving base station, and the second base station may be a secondary (e.g., for carrier aggregation) or neighboring base station. The UE may establish a transmit-receive beam pair with the first base station, as the serving base station. The first and second base stations may be configured to transmit frequency-division multiplexed PRS to the UE. The UE can measure the PRS from the first (serving) base station using the established beam pair, and will need to attempt to measure the PRS from the second base station using that same receive beam. Depending on the locations of the base stations, the UE may not be able to capture the PRS from the second base station.

For example, the best beam pairs for the two base stations may be (2, 3) for the first base station and (5, 4) for the second base station, where each pair of numbers represents a beam pair, in which the first number is an identifier of the downlink transmit beam and the second number is an identifier of the downlink receive beam. Due to the limitation of analog beamforming, the UE can only select one receive beam, and chooses receive beam “3” for the first base station. For PRS from the second base station (and other base stations), the best, or at least selected, transmit beam is still transmit beam “5,” which may not be the optimal selection given the current receive beam. For example, using receive beam “3” instead of receive beam “4” may result in lower beamforming gain.

Accordingly, it may be impossible, or at least result in lower positioning accuracy, for a UE performing positioning procedures in mmW and other beam-based communications systems (e.g., FR2, FR3, FR4) to be configured to measure frequency-division multiplexed PRS. As such, the present disclosure describes techniques for beam management in mmW and other beam-based positioning systems using FDM.

The techniques of the present disclosure may be triggered by various events. For example, a trigger may be the signal strength (e.g., RSRP, RSRQ, SINR, etc.) of PRS from other base stations decreasing below some threshold. This is similar to a beam failure trigger, as described above with reference to FIG. 12. Another trigger may be that the UE is configured with a new FDM PRS configuration.

There are various cases to which the present techniques apply. A first case is where the UE has prior knowledge of which transmit beam(s) from which base station(s) are better for receiving PRS (which may have been stored from the beam pair searching phase). A second is where the UE has no prior knowledge of which transmit beam(s) are better due to outdated knowledge. A third is where the UE has no prior knowledge of which transmit beam(s) are better due to being configured to measure a new base station.

The general procedure for each of the three cases described above is that, in a first stage, the UE receives a given PRS configuration for two or more component PRS through RRC signaling. The UE then searches, for each base station for which it is configured to measure the component PRS, for the beam pair(s) that contain(s) the earliest arriving (i.e., LOS or shortest NLOS) path for the configured PRS, and finds ‘N’ receive beam options for a comb-N PRS configuration. In a second stage, the UE decides which receive beam to use to capture the combined PRS. In a third stage, the UE measures all component PRS, and monitors any variation between the signal strength of the measured PRS and the signal strength measured during the first stage (the beam pair stage) for each base station (or TRP/cell). In a fourth stage, if the UE finds that a subset of the base stations suffers a loss of signal strength greater than some threshold, then it will trigger a new procedure to correct (refine) the transmit beams used by the involved base stations.

In an aspect, after the first stage (i.e., after acquisition of all frequency division multiplexed and time division multiplexed PRS), the UE can propose a new PRS configuration based on the results of the transmit-receive beam pairing(s). For example, the UE may suggest reconfiguring a first PRS in a first slot (or other time interval or transmission time) to a second slot (or other time interval or transmission time) and a second PRS in the second slot to the first slot based on the new transmit-receive beam pairings for that PRS. A detailed example is provided below.

As a detailed example, for an initial PRS configuration for a first FDM PRS in a first slot (or other time interval or transmission time), the best beam pairs for two base stations transmitting component PRS may be (2, 3) for the first base station and (3, 4) for the second base station, where each pair of numbers represents a beam pair, in which the first number is an identifier of the transmit beam and the second number is an identifier of the receive beam. For the initial PRS configuration for a second FDM PRS in a second slot, the best beam pairs for a third and fourth base station may be (7, 3) for the third base station and (5, 4) for the fourth base station.

In the present example, the PRS configuration would work better for the UE if the location server reconfigured the PRS such that in the first slot, the UE measured PRS from the first and third base stations, and in the second slot, measured PRS from the second and fourth base stations. That is, the UE would now measure PRS from the first and third base stations in the same slot, rather than the first and second slots, and measure PRS from the second and fourth base stations in the same slot, rather than the third and fourth slots. This is because the receive beams are the same for the first and third base stations and the second and fourth base stations.

The UE can send the request to reconfigure the PRS to the serving base station through uplink control information (UCI), MAC control element (MAC-CE) on a PUCCH, or RRC signaling on a PUSCH. Alternatively or additionally, the UE can integrate the request into the measurement package sent to the location server (e.g., location server 230, LMF 270, SLP 272) through an LTE positioning protocol (LPP) session with the location server. If the serving base station receives the request, it can send the request to the location server via LPP type A (LPPa) or New Radio positioning protocol type A (NRPPa), and/or to the other base station(s) via the backhaul interface (e.g., Xn). If the serving base station transmits the request to the other base station(s) and not the location server, the location server may still obtain the request by intercepting the request as it is transmitted over the backhaul.

Once the location server receives the request, it can decide whether or not it can accept the requested reconfiguration. If it can, it will send the new PRS configuration to the involved base stations, which will update their PRS configurations. The location server can send an indication of its decision to the UE through, for example, a PDCCH from the serving base station or LPP session (which would be an explicit indication), or take no action (which would be an implicit indication). If the location server indicates that it has adopted the UE's requested PRS configuration, it does not necessarily need to send the new configuration to the UE, as the UE proposed it. However, if the location server needed to make changes to the proposed reconfiguration (e.g., symbol offset, slot offset, comb type, etc.), it should send the new PRS configuration to the UE.

Note that for PRS reconfiguration, as described above, the UE needs to be configured to measure PRS from more than two base station, as the minimum comb size is comb-2.

Referring now to the first case described above (i.e., the UE has prior knowledge of which transmit beam(s) are better for receiving PRS), if the UE knows a better candidate transmit beam for one or more of the non-serving base stations, it can transmit a request to update the transmit beam(s) for those base stations to the better candidate transmit beam(s). The UE can transmit the request to the serving base station through UCI, a MAC-CE on a PUCCH, or RRC signaling on a PUSCH. Alternatively or additionally, the UE can integrate the request into the measurement package sent to the location server (e.g., location server 230, LMF 270, SLP 272) through an LPP session.

If the serving base station receives the request, it can send the request to the location server via the core network (e.g., 5GC 260), and/or to the other base station(s) via the backhaul interface (e.g., Xn). If the target base station(s) receive the request, they can determine whether or not to switch to the requested transmit beam. Similarly, if the request goes to the location server, the location server can decide whether or not the transmit beam at the other base station(s) need(s) adjustment. Note that if the serving base station transmits the request to the other base station(s) and not the location server, the location server may still be able to obtain the request by intercepting the request as it is transmitted over the backhaul.

Referring to the second case described above, if the UE has no prior knowledge of which transmit beam(s) are better (due to outdated knowledge), the UE can transmit a request to perform a new beam pair search procedure. The UE can send the request to the serving base station through UCI, MAC-CE, or RRC, the same as described above for the first case. Alternatively or additionally, as also described above, the UE can integrate the request into the measurement package sent to the location server (e.g., location server 230, LMF 270, SLP 272) through an LPP session with the location server.

If the serving base station receives the request, it can send the request to the location server via the core network, and/or to the other base station(s) via the backhaul interface (e.g., Xn). If the serving base station transmits the request to the other base station(s) and not the location server, the location server may still obtain the request by intercepting the request as it is transmitted over the backhaul. Once the location server receives the request, it can decide whether or not a new beam pair search procedure can be initialized given the current resource availability. If resources are available, the location server can allocate resource for PRS pairing, and the UE and the other base station(s) can perform the beam pairing procedure, as described above with reference to FIG. 12. If resources are not available, the location server can instruct the UE to reinitialize beam acquisition, in which case, the UE will perform a new random access procedure, as described above with reference to FIGS. 8A and 8B.

In an aspect, the beam search procedure may be an on-demand beam pair search procedure (partial, whole, or transmit only). In addition, the UE can also send a request to the location server to pause the positioning session until the beam pairing procedure is completed.

Referring to the third case described above, this case is similar to the second case, but the UE directly requests a beam acquisition procedure. If permitted, the UE will perform a new random access procedure, as described above with reference to FIGS. 8A and 8B.

For all three cases described above, the UE can also propose a PRS reconfiguration based on the updated pairing results or signal strength related measurements, similar to after the first stage, as described above. For example, the UE may suggest reconfiguring a first PRS in a first slot to a second slot and a second PRS in the second slot to the first slot based on the transmit-receive beam pairings for that PRS. A detailed example was provided above with reference to the first stage, and is not repeated here for the sake of brevity.

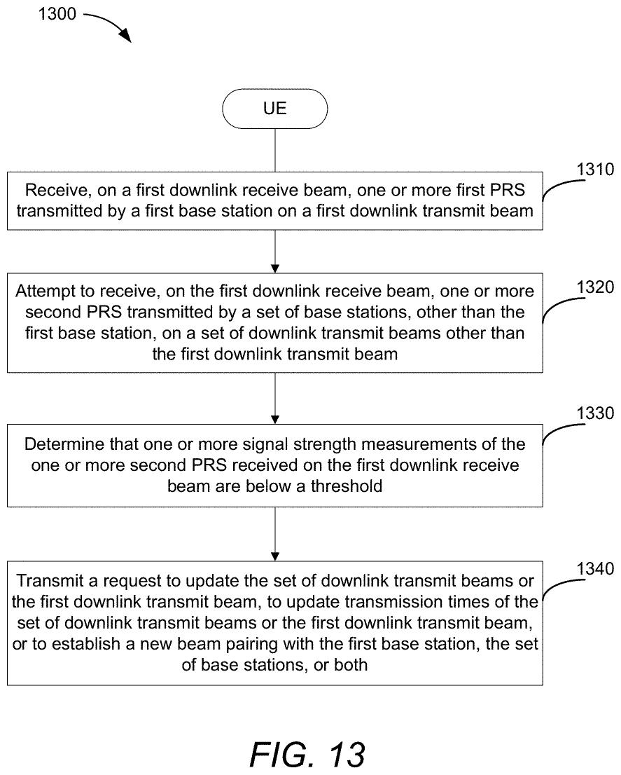

FIG. 13 illustrates an example method 1300 of wireless communication, according to aspects of the disclosure. The method 1300 may be performed by a UE (e.g., any of the UEs described herein).

At 1310, the UE receives, on a first downlink receive beam, one or more first PRS transmitted by a first base station (e.g., any of the base stations described herein) on a first downlink transmit beam. In an aspect, operation 1310 may be performed by WWAN transceiver 310, processing system 332, memory component 340, and/or positioning component 342, any or all of which may be considered means for performing this operation.

At 1320, the UE attempts to receive, on the first downlink receive beam, one or more second PRS transmitted by a set of base stations (e.g., any of the base stations described herein), other than the first base station, on a set of downlink transmit beams other than the first downlink transmit beam. In an aspect, operation 1320 may be performed by WWAN transceiver 310, processing system 332, memory component 340, and/or positioning component 342, any or all of which may be considered means for performing this operation.

At 1330, the UE determines that one or more signal strength measurements of the one or more second PRS received on the first downlink receive beam are below a threshold. In an aspect, operation 1330 may be performed by WWAN transceiver 310, processing system 332, memory component 340, and/or positioning component 342, any or all of which may be considered means for performing this operation.

At 1340, the UE transmits a request to update the set of downlink transmit beams or the first downlink transmit beam, to update transmission times of the set of downlink transmit beams or the first downlink transmit beam, or to establish a new beam pairing with the first base station, the set of base stations, or both. In an aspect, operation 1340 may be performed by WWAN transceiver 310, processing system 332, memory component 340, and/or positioning component 342, any or all of which may be considered means for performing this operation.

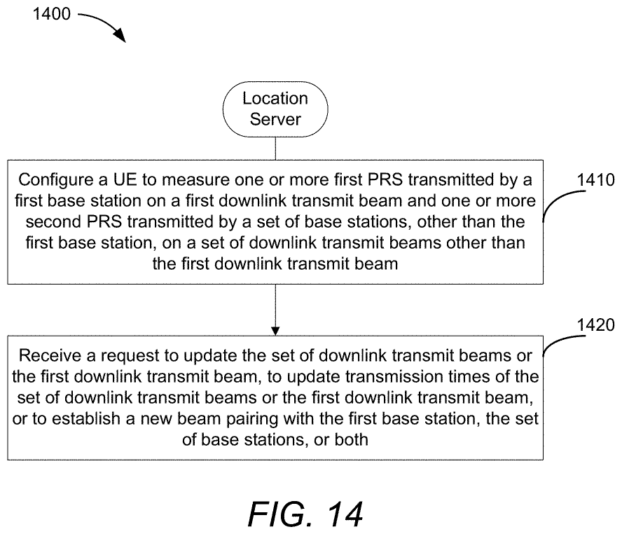

FIG. 14 illustrates an example method 1400 of communication, according to aspects of the disclosure. The method 1400 may be performed by a location server, such as location server 230, LMF 270, or SLP 272.

At 1410, the location server configures a UE (e.g., any of the UEs described herein) to measure one or more first PRS transmitted by a first base station (e.g., any of the base stations described herein) on a first downlink transmit beam and one or more second PRS transmitted by a set of base stations (e.g., any of the base stations described herein), other than the first base station, on a set of downlink transmit beams other than the first downlink transmit beam. In an aspect, operation 1410 may be performed by network interface(s) 390, processing system 394, memory component 396, and/or positioning component 398, any or all of which may be considered means for performing this operation.

At 1420, the location server receives a request to update the set of downlink transmit beams or the first downlink transmit beam, to update transmission times of the set of downlink transmit beams or the first downlink transmit beam, or to establish a new beam pairing with the first base station, the set of base stations, or both. In an aspect, operation 1410 may be performed by network interface(s) 390, processing system 394, memory component 396, and/or positioning component 398, any or all of which may be considered means for performing this operation.

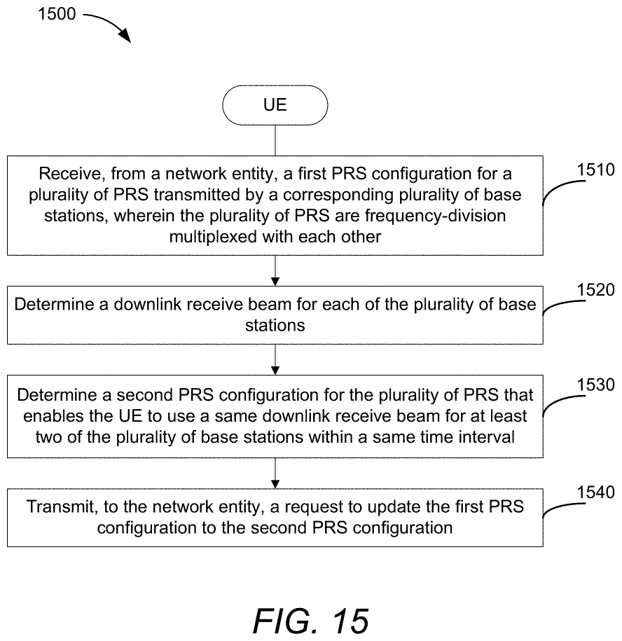

FIG. 15 illustrates an example method 1500 of wireless communication, according to aspects of the disclosure. The method 1500 may be performed by a UE (e.g., any of the UEs described herein).

At 1510, the UE receives, from a network entity (e.g., a serving base station, a location server), a first PRS configuration for a plurality of PRS transmitted by a corresponding plurality of base stations. In an aspect, the plurality of PRS may be frequency-division multiplexed with each other. In an aspect, operation 1510 may be performed by WWAN transceiver 310, processing system 332, memory component 340, and/or positioning component 342, any or all of which may be considered means for performing this operation.

At 1520, the UE determines a downlink receive beam for each of the plurality of base stations. In an aspect, operation 1520 may be performed by WWAN transceiver 310, processing system 332, memory component 340, and/or positioning component 342, any or all of which may be considered means for performing this operation.

At 1530, the UE determines a second PRS configuration for the plurality of PRS that enables the UE to use a same downlink receive beam for at least two of the plurality of base stations within a same time interval. In an aspect, operation 1530 may be performed by WWAN transceiver 310, processing system 332, memory component 340, and/or positioning component 342, any or all of which may be considered means for performing this operation.

At 1540, the UE transmits, to the network entity, a request to update the first PRS configuration to the second PRS configuration. In an aspect, operation 1540 may be performed by WWAN transceiver 310, processing system 332, memory component 340, and/or positioning component 342, any or all of which may be considered means for performing this operation.

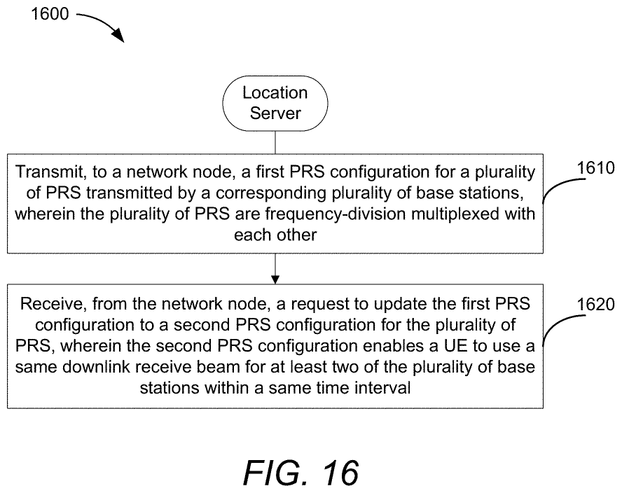

FIG. 16 illustrates an example method 1600 of communication, according to aspects of the disclosure. The method 1600 may be performed by a location server, such as location server 230, LMF 270, or SLP 272.

At 1610, the location server transmits, to a network node (e.g., a UE or the UE's serving base station), a first PRS configuration for a plurality of PRS transmitted by a corresponding plurality of base stations. In an aspect, the plurality of PRS may be frequency-division multiplexed with each other. In an aspect, operation 1610 may be performed by network interface(s) 390, processing system 394, memory component 396, and/or positioning component 398, any or all of which may be considered means for performing this operation.

At 1620, the location server receives, from the network node, a request to update the first PRS configuration to a second PRS configuration for the plurality of PRS, wherein the second PRS configuration enables a UE (e.g., any of the UEs described herein) to use a same downlink receive beam for at least two of the plurality of base stations within a same time interval. In an aspect, operation 1620 may be performed by network interface(s) 390, processing system 394, memory component 396, and/or positioning component 398, any or all of which may be considered means for performing this operation.

At 1630, the location server optionally transmits the second PRS configuration to the plurality of base stations. Operation 1430 is optional because the location server may decide not to update the first PRS configuration to the second PRS configuration. In an aspect, operation 1630 may be performed by network interface(s) 390, processing system 394, memory component 396, and/or positioning component 398, any or all of which may be considered means for performing this operation.

As will be appreciated, a technical advantage of the methods 1300 to 1600 is better signal strength for FDM PRS and better signal strength for the earliest path detection, and therefore, better ToA estimation and better positioning performance.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: receiving, on a first downlink receive beam, one or more first positioning reference signals (PRS) transmitted by a first base station on a first downlink transmit beam; attempting to receive, on the first downlink receive beam, one or more second PRS transmitted by a set of base stations, other than the first base station, on a set of downlink transmit beams other than the first downlink transmit beam; determining that one or more signal strength measurements of the one or more second PRS received on the first downlink receive beam is below corresponding thresholds; and transmitting a request to update the second set of downlink transmit beams, or to establish a new beam pairing with the first base station, the set of base stations, or both.

Clause 2. The method of clause 1, wherein the first base station is a serving base station for the UE.

Clause 3. The method of clause 2, wherein the UE transmits the request to the serving base station via uplink control information (UCI), a medium access control element (MAC CE) through a physical uplink control channel (PUCCH), or radio resource control (RRC) through a physical uplink shared channel (PUSCH).

Clause 4. The method of clause 3, wherein the UE transmits the request to the serving base station to enable the serving base station to forward the request to a location server.

Clause 5. The method of any of clauses 1 to 2, wherein the UE transmits the request to a location server via Long-Term Evolution (LTE) positioning protocol (LPP).

Clause 6. The method of any of clauses 1 to 5, wherein the request is to update the set of downlink transmit beams to a second set of downlink transmit beams used by the set of base stations.

Clause 7. The method of clause 6, wherein the second set of downlink transmit beams is known by the UE to have better reception characteristics at the UE.

Clause 8. The method of any of clauses 1 to 5, wherein the request is to establish the new beam pairing with the set of base stations.

Clause 9. The method of clause 8, further comprising: transmitting, to a location server, a request for the first base station and the set of base stations to pause transmission of PRS during establishment of the new beam pairing.

Clause 10. The method of any of clauses 8 to 9, wherein the request being to establish the new beam pairing with the set of base stations comprises the request being a beam acquisition request.

Clause 11. The method of any of clauses 1 to 10, further comprising: transmitting a proposed PRS reconfiguration for a subset of all base stations configured to transmit PRS to the UE.

Clause 12. The method of clause 11, wherein the UE transmits the proposed PRS reconfiguration based on the updated set of downlink transmit beams, or based on the new beam pairing with the first base station, the set of base stations, or both.

Clause 13. The method of any of clauses 11 to 12, wherein the UE transmits the proposed PRS reconfiguration based on new signal strength measurements.

Clause 14. The method of any of clauses 11 to 13, wherein the UE transmits the proposed PRS reconfiguration based on a determination that the proposed PRS reconfiguration is better than a current PRS configuration for at least the first base station or the set of base stations from a downlink receive beam perspective.

Clause 15. The method of any of clauses 11 to 14, wherein the UE transmits the proposed PRS reconfiguration to the first base station via UCI, a MAC CE through a PUCCH, or RRC through a PUSCH.

Clause 16. The method of any of clauses 11 to 15, wherein the UE transmits the proposed PRS reconfiguration to the first base station to enable the first base station to forward the request to a location server.

Clause 17. The method of any of clauses 11 to 14, wherein the UE transmits the proposed PRS reconfiguration to a location server via LPP.

Clause 18. The method of any of clauses 1 to 17, wherein the one or more first PRS and the one or more second PRS are frequency-division multiplexed with each other.

Clause 19. A method of communication performed by a location server, comprising: configuring a user equipment (UE) to measure one or more first positioning reference signals (PRS) transmitted by a first base station on a first downlink transmit beam and one or more second PRS transmitted by a set of base stations, other than the first base station, on a set of downlink transmit beams other than the first downlink transmit beam; and receiving a request to update the set of downlink transmit beams, or to establish a new beam pairing with the first base station, the set of base stations, or both.

Clause 20. The method of clause 19, wherein the location server receives the request from the first base station, and wherein the first base station is a serving base station for the UE.

Clause 21. The method of clause 19, wherein the location server receives the request from the UE via Long-Term Evolution (LTE) positioning protocol (LPP).

Clause 22. The method of any of clauses 19 to 21, wherein the request is to update the set of downlink transmit beams to a second set of downlink transmit beams used by the set of base stations.

Clause 23. The method of clause 22, wherein the second set of downlink transmit beams is known by the UE to have better reception characteristics at the UE.

Clause 24. The method of any of clauses 19 to 21, wherein the request is to establish the new beam pairing with the set of base stations.

Clause 25. The method of clause 24, further comprising: receiving, from the UE, a request for the first base station and the set of base stations to pause transmission of PRS during establishment of the new beam pairing.

Clause 26. The method of any of clauses 24 to 25, wherein the request being to establish the new beam pairing with the set of base stations comprises the request being a beam acquisition request.

Clause 27. The method of any of clauses 19 to 26, further comprising: receiving a proposed PRS reconfiguration for a subset of all base stations configured to transmit PRS to the UE.

Clause 28. The method of clause 27, wherein the location server receives the proposed PRS reconfiguration based on the updated set of downlink transmit beams, or based on the new beam pairing with the first base station, the set of base stations, or both.

Clause 29. The method of any of clauses 27 to 28, wherein the location server receives the proposed PRS reconfiguration based on new signal strength measurements.

Clause 30. The method of any of clauses 27 to 29, wherein the location server receives the proposed PRS reconfiguration based on a determination by the UE that the proposed PRS reconfiguration is better than a current PRS configuration for at least the first base station or the set of base stations from a downlink receive beam perspective.

Clause 31. The method of any of clauses 27 to 30, wherein the location server receives the proposed PRS reconfiguration from the first base station.

Clause 32. The method of any of clauses 27 to 30, wherein the location server receives the proposed PRS reconfiguration from the UE via LPP.

Clause 33. The method of any of clauses 19 to 32, wherein the one or more first PRS and the one or more second PRS are frequency-division multiplexed with each other.

Clause 34. A method of wireless communication performed by a user equipment (UE), comprising: receiving, from a network entity, a first positioning reference signal (PRS) configuration for a plurality of PRS transmitted by a corresponding plurality of base stations, wherein the plurality of PRS are frequency-division multiplexed with each other; determining a downlink receive beam for each of the plurality of base stations; determining a second PRS configuration for the plurality of PRS that enables the UE to use a same downlink receive beam for at least two of the plurality of base stations within a same time interval; and transmitting, to the network entity, a request to update the first PRS configuration to the second PRS configuration.

Clause 35. The method of clause 34, wherein the same time interval comprises one or more symbols, a slot, or a subframe.

Clause 36. The method of any of clauses 34 to 35, wherein the downlink receive beam for each of the plurality of base stations is a downlink receive beam that enables the UE to receive the corresponding PRS on a shortest path between the UE and the base station.

Clause 37. The method of any of clauses 34 to 36, wherein the network entity comprises a location server, and wherein the UE receives the first PRS configuration via a Long-Term Evolution (LTE) positioning protocol (LPP) session.

Clause 38. The method of any of clauses 34 to 36, wherein the network entity comprises a serving base station, and wherein the UE transmits the second PRS configuration to the serving base station via uplink control information (UCI), a medium access control control element (MAC CE) on a physical uplink control channel (PUCCH), or radio resource control (RRC) signaling on a physical uplink shared channel (PUSCH).

Clause 39. The method of any of clauses 34 to 38, wherein the UE transmits the second PRS configuration to the serving base station to enable the serving base station to forward the request to a location server.

Clause 40. A method of communication performed by a location server, comprising: transmitting, to a network node, a first positioning reference signal (PRS) configuration for a plurality of PRS transmitted by a corresponding plurality of base stations, wherein the plurality of PRS are frequency-division multiplexed with each other; and receiving, from the network node, a request to update the first PRS configuration to a second PRS configuration for the plurality of PRS, wherein the second PRS configuration enables a user equipment (UE) to use a same downlink receive beam for at least two of the plurality of base stations within a same time interval.

Clause 41. The method of clause 40, wherein the same time interval comprises one or more symbols, a slot, or a subframe.

Clause 42. The method of any of clauses 40 to 41, wherein the network node is the UE, and wherein the location server transmits the first PRS configuration and receives the second PRS configuration via a Long-Term Evolution (LTE) positioning protocol (LPP) session.

Clause 43. The method of any of clauses 40 to 41, wherein the network node is a serving base station for the UE, and wherein the location server transmits the first PRS configuration and receives the second PRS configuration via an LTE positioning protocol type A (LPPa) or a New Radio positioning protocol type A (NRPPa) session.

Clause 44. The method of any of clauses 40 to 43, further comprising: transmitting the second PRS configuration to the plurality of base stations.

Clause 45. An apparatus comprising a memory and at least one processor communicatively coupled to the memory, the memory and the at least one processor configured to perform a method according to any of clauses 1 to 44.

Clause 46. An apparatus comprising means for performing a method according to any of clauses 1 to 44.

Clause 47. A non-transitory computer-readable medium storing computer-executable instructions, the computer-executable comprising at least one instruction for causing a computer or processor to perform a method according to any of clauses 1 to 44.

Additional implementation examples are described in the following numbered clauses:

Clause 1. A method of wireless communication performed by a user equipment (UE), comprising: receiving, on a first downlink receive beam, one or more first positioning reference signals (PRS) transmitted by a first base station on a first downlink transmit beam; attempting to receive, on the first downlink receive beam, one or more second PRS transmitted by a set of base stations, other than the first base station, on a set of downlink transmit beams other than the first downlink transmit beam; determining that one or more signal strength measurements of the one or more second PRS received on the first downlink receive beam are below a threshold; and transmitting a request to update the set of downlink transmit beams or the first downlink transmit beam, to update transmission times of the set of downlink transmit beams or the first downlink transmit beam, or to establish a new beam pairing with the first base station, the set of base stations, or both.

Clause 2. The method of clause 1, wherein the UE transmits the request to the first base station to enable the first base station to forward the request to a location server.

Clause 3. The method of any of clauses 1 to 2, wherein: the request is to update the set of downlink transmit beams to a second set of downlink transmit beams used by the set of base stations, and the second set of downlink transmit beams is known by the UE to have better reception characteristics at the UE.

Clause 4. The method of any of clauses 1 to 2, wherein the request is to establish the new beam pairing with the set of base stations.

Clause 5. The method of clause 4, wherein the request being to establish the new beam pairing with the set of base stations comprises the request being a beam acquisition request.

Clause 6. The method of any of clauses 1 to 5, further comprising: transmitting a proposed PRS reconfiguration for a subset of all base stations configured to transmit PRS to the UE.

Clause 7. The method of clause 6, wherein the UE transmits the proposed PRS reconfiguration based on: the updated set of downlink transmit beams or the first downlink transmit beam, the updated transmission times of the set of downlink transmit beams or the first downlink transmit beam, or based on the new beam pairing with the first base station, the set of base stations, or both, new signal strength measurements, or a determination that the proposed PRS reconfiguration is better than a current PRS configuration for at least the first base station or the set of base stations from a downlink receive beam perspective.

Clause 8. The method of any of clauses 6 to 7, wherein the UE transmits the proposed PRS reconfiguration to the first base station to enable the first base station to forward the request to a location server.

Clause 9. The method of any of clauses 6 to 7, wherein the UE transmits the proposed PRS reconfiguration to a location server.

Clause 10. The method of any of clauses 1 to 9, wherein the one or more first PRS and the one or more second PRS are frequency-division multiplexed with each other.

Clause 11. A method of communication performed by a location server, comprising: configuring a user equipment (UE) to measure one or more first positioning reference signals (PRS) transmitted by a first base station on a first downlink transmit beam and one or more second PRS transmitted by a set of base stations, other than the first base station, on a set of downlink transmit beams other than the first downlink transmit beam; and receiving a request to update the set of downlink transmit beams or the first downlink transmit beam, to update transmission times of the set of downlink transmit beams or the first downlink transmit beam, or to establish a new beam pairing with the first base station, the set of base stations, or both.

Clause 12. The method of clause 11, wherein the location server receives the request from the first base station.

Clause 13. The method of any of clauses 11 to 12, wherein: the request is to update the set of downlink transmit beams to a second set of downlink transmit beams used by the set of base stations, and the second set of downlink transmit beams is known by the UE to have better reception characteristics at the UE.

Clause 14. The method of any of clauses 11 to 12, wherein the request is to establish the new beam pairing with the set of base stations.

Clause 15. The method of clause 14, wherein the request being to establish the new beam pairing with the set of base stations comprises the request being a beam acquisition request.

Clause 16. The method of any of clauses 11 to 15, further comprising: receiving a proposed PRS reconfiguration for a subset of all base stations configured to transmit PRS to the UE.

Clause 17. The method of clause 16, wherein the location server receives the proposed PRS reconfiguration based on: the updated set of downlink transmit beams or the first downlink transmit beam, the updated transmission times of the set of downlink transmit beams or the first downlink transmit beam, or based on the new beam pairing with the first base station, the set of base stations, or both, new signal strength measurements, or a determination by the UE that the proposed PRS reconfiguration is better than a current PRS configuration for at least the first base station or the set of base stations from a downlink receive beam perspective.

Clause 18. The method of any of clauses 16 to 17, wherein the location server receives the proposed PRS reconfiguration from the first base station.

Clause 19. The method of any of clauses 16 to 17, wherein the location server receives the proposed PRS reconfiguration from the UE.

Clause 20. The method of any of clauses 11 to 19, wherein the one or more first PRS and the one or more second PRS are frequency-division multiplexed with each other.

Clause 21. A method of wireless communication performed by a user equipment (UE), comprising: receiving, from a network entity, a first positioning reference signal (PRS) configuration for a plurality of PRS transmitted by a corresponding plurality of base stations, wherein the plurality of PRS are frequency-division multiplexed with each other; determining a downlink receive beam for each of the plurality of base stations; determining a second PRS configuration for the plurality of PRS that enables the UE to use a same downlink receive beam for at least two of the plurality of base stations within a same time interval; and transmitting, to the network entity, a request to update the first PRS configuration to the second PRS configuration.

Clause 22. The method of clause 21, wherein the same time interval comprises one or more symbols, a slot, or a subframe.

Clause 23. The method of any of clauses 21 to 24, wherein the downlink receive beam for each of the plurality of base stations is a downlink receive beam that enables the UE to receive the corresponding PRS on a shortest path between the UE and the base station.

Clause 24. The method of any of clauses 21 to 25, wherein the network entity is: a location server, or a serving base station.

Clause 25. The method of any of clauses 21 to 26, wherein the UE transmits the second PRS configuration to a serving base station to enable the serving base station to forward the request to a location server.

Clause 26. The method of any of clauses 21 to 25, wherein: the first PRS configuration indicates a first set of downlink transmit beams for the plurality of PRS, transmission times of the first set of downlink transmit beams, or both, and the second PRS configuration indicates a second set of downlink transmit beams for the plurality of PRS, transmission times of the second set of downlink transmit beams, or both.

Clause 27. A method of communication performed by a location server, comprising: transmitting, to a network node, a first positioning reference signal (PRS) configuration for a plurality of PRS transmitted by a corresponding plurality of base stations, wherein the plurality of PRS are frequency-division multiplexed with each other; and receiving, from the network node, a request to update the first PRS configuration to a second PRS configuration for the plurality of PRS, wherein the second PRS configuration enables a user equipment (UE) to use a same downlink receive beam for at least two of the plurality of base stations within a same time interval.

Clause 28. The method of clause 27, wherein the same time interval comprises one or more symbols, a slot, or a subframe.

Clause 29. The method of any of clauses 27 to 28, wherein the network node is: the UE, or a serving base station for the UE.

Clause 30. The method of any of clauses 27 to 29, further comprising: transmitting the second PRS configuration to the plurality of base stations.

Clause 31. The method of any of clauses 27 to 30, wherein: the first PRS configuration indicates a first set of downlink transmit beams for the plurality of PRS, transmission times of the first set of downlink transmit beams, or both, and the second PRS configuration indicates a second set of downlink transmit beams for the plurality of PRS, transmission times of the second set of downlink transmit beams, or both.

Clause 32. An apparatus comprising a memory and at least one processor communicatively coupled to the memory, the memory and the at least one processor configured to perform a method according to any of clauses 1 to 31.

Clause 33. An apparatus comprising means for performing a method according to any of clauses 1 to 31.

Clause 34. A non-transitory computer-readable medium storing computer-executable instructions, the computer-executable comprising at least one instruction for causing a computer or processor to perform a method according to any of clauses 1 to 31.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In an aspect, a non-transitory computer-readable medium storing computer-executable instructions may include computer-executable instructions comprising: at least one instruction instructing a user equipment (UE) to receive, on a first downlink receive beam, one or more first positioning reference signals (PRS) transmitted by a first base station on a first downlink transmit beam; at least one instruction instructing the UE to attempt to receive, on the first downlink receive beam, one or more second PRS transmitted by a set of base stations, other than the first base station, on a set of downlink transmit beams other than the first downlink transmit beam; at least one instruction instructing the UE to determine that one or more signal strength measurements of the one or more second PRS received on the first downlink receive beam is below a threshold; and at least one instruction instructing the UE to transmit a request to update the set of downlink transmit beams or the first downlink transmit beam, to update transmission times of the set of downlink transmit beams or the first downlink transmit beam, or to establish a new beam pairing with the first base station, the set of base stations, or both.

In an aspect, a non-transitory computer-readable medium storing computer-executable instructions may include computer-executable instructions comprising: at least one instruction instructing a location server to configure a user equipment (UE) to measure one or more first positioning reference signals (PRS) transmitted by a first base station on a first downlink transmit beam and one or more second PRS transmitted by a set of base stations, other than the first base station, on a set of downlink transmit beams other than the first downlink transmit beam; and at least one instruction instructing the location server to receive a request to update the set of downlink transmit beams or the first downlink transmit beam, to update transmission times of the set of downlink transmit beams or the first downlink transmit beam, or to establish a new beam pairing with the first base station, the set of base stations, or both.

In an aspect, a non-transitory computer-readable medium storing computer-executable instructions may include computer-executable instructions comprising: at least one instruction instructing a user equipment (UE) to receive, from a network entity, a first positioning reference signal (PRS) configuration for a plurality of PRS transmitted by a corresponding plurality of base stations, wherein the plurality of PRS are frequency-division multiplexed with each other; at least one instruction instructing the UE to determine a downlink receive beam for each of the plurality of base stations; at least one instruction instructing the UE to determine a second PRS configuration for the plurality of PRS that enables the UE to use a same downlink receive beam for at least two of the plurality of base stations within a same time interval; and at least one instruction instructing the UE to transmit, to the network entity, the second PRS configuration for the plurality of PRS.

In an aspect, a non-transitory computer-readable medium storing computer-executable instructions may include computer-executable instructions comprising: at least one instruction instructing a location server to transmit, to a network node, a first positioning reference signal (PRS) configuration for a plurality of PRS transmitted by a corresponding plurality of base stations, wherein the plurality of PRS are frequency-division multiplexed with each other; and at least one instruction instructing the location server to receive, from the network node, a request to update the first PRS configuration to a second PRS configuration for the plurality of PRS, wherein the second PRS configuration enables a user equipment (UE) to use a same downlink receive beam for at least two of the plurality of base stations within a same time interval.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a user equipment (UE), comprising:
receiving, on a first downlink receive beam, one or more first positioning reference signals (PRS) transmitted by a first base station on a first downlink transmit beam;
attempting to receive, on the first downlink receive beam, one or more second PRS transmitted by a set of base stations, other than the first base station, on a set of downlink transmit beams other than the first downlink transmit beam;
determining that one or more signal strength measurements of the one or more second PRS received on the first downlink receive beam are below a threshold; and
transmitting a request to update the set of downlink transmit beams or the first downlink transmit beam, to update transmission times of the set of downlink transmit beams or the first downlink transmit beam, or to establish a new beam pairing with the first base station, the set of base stations, or both.

2. The method of claim 1, wherein the UE transmits the request to the first base station to enable the first base station to forward the request to a location server.

3. The method of claim 1, wherein:
the request is to update the set of downlink transmit beams to a second set of downlink transmit beams used by the set of base stations, and
the second set of downlink transmit beams is known by the UE to have better reception characteristics at the UE.

4. The method of claim 1, wherein the request is to establish the new beam pairing with the set of base stations.

5. The method of claim 4, wherein the request being to establish the new beam pairing with the set of base stations comprises the request being a beam acquisition request.

6. The method of claim 1, further comprising:
transmitting a proposed PRS reconfiguration for a subset of all base stations configured to transmit PRS to the UE.

7. The method of claim 6, wherein the UE transmits the proposed PRS reconfiguration based on:
the updated set of downlink transmit beams or the first downlink transmit beam, the updated transmission times of the set of downlink transmit beams or the first downlink transmit beam, or the new beam pairing with the first base station, the set of base stations, or both,
new signal strength measurements, or
a determination that the proposed PRS reconfiguration is better than a current PRS configuration for at least the first base station or the set of base stations from a downlink receive beam perspective.

8. The method of claim 6, wherein the UE transmits the proposed PRS reconfiguration to the first base station to enable the first base station to forward the request to a location server.

9. The method of claim 6, wherein the UE transmits the proposed PRS reconfiguration to a location server.

10. The method of claim 1, wherein the one or more first PRS and the one or more second PRS are frequency-division multiplexed with each other.

11. A method of communication performed by a location server, comprising:
configuring a user equipment (UE) to measure one or more first positioning reference signals (PRS) transmitted by a first base station on a first downlink transmit beam and one or more second PRS transmitted by a set of base stations, other than the first base station, on a set of downlink transmit beams other than the first downlink transmit beam; and
receiving a request to update the set of downlink transmit beams or the first downlink transmit beam, to update transmission times of the set of downlink transmit beams or the first downlink transmit beam, or to establish a new beam pairing with the first base station, the set of base stations, or both.

12. The method of claim 11, wherein the location server receives the request from the first base station.

13. The method of claim 11, wherein:
the request is to update the set of downlink transmit beams to a second set of downlink transmit beams used by the set of base stations, and
the second set of downlink transmit beams is known by the UE to have better reception characteristics at the UE.

14. The method of claim 11, wherein the request is to establish the new beam pairing with the set of base stations.

15. The method of claim 14, wherein the request being to establish the new beam pairing with the set of base stations comprises the request being a beam acquisition request.

16. The method of claim 11, further comprising:
receiving a proposed PRS reconfiguration for a subset of all base stations configured to transmit PRS to the UE.

17. The method of claim 16, wherein the location server receives the proposed PRS reconfiguration based on:
the updated set of downlink transmit beams or the first downlink transmit beam, the updated transmission times of the set of downlink transmit beams or the first downlink transmit beam, or the new beam pairing with the first base station, the set of base stations, or both,
new signal strength measurements, or
a determination by the UE that the proposed PRS reconfiguration is better than a current PRS configuration for at least the first base station or the set of base stations from a downlink receive beam perspective.

18. The method of claim 16, wherein the location server receives the proposed PRS reconfiguration from the first base station.

19. The method of claim 16, wherein the location server receives the proposed PRS reconfiguration from the UE.

20. The method of claim 11, wherein the one or more first PRS and the one or more second PRS are frequency-division multiplexed with each other.

21. A method of wireless communication performed by a user equipment (UE), comprising:
receiving, from a network entity, a first positioning reference signal (PRS) configuration for a plurality of PRS transmitted by a corresponding plurality of base stations, wherein the plurality of PRS are frequency-division multiplexed with each other;
determining a downlink receive beam for each of the plurality of base stations;
determining a second PRS configuration for the plurality of PRS that enables the UE to use a same downlink receive beam for at least two of the plurality of base stations within a same time interval; and
transmitting, to the network entity, a request to update the first PRS configuration to the second PRS configuration.

22. The method of claim 21, wherein the same time interval comprises one or more symbols, a slot, or a subframe.

23. The method of claim 21, wherein the downlink receive beam for each of the plurality of base stations is a downlink receive beam that enables the UE to receive the corresponding PRS on a shortest path between the UE and the base station.

24. The method of claim 21, wherein the network entity is:
a location server, or
a serving base station.

25. The method of claim 21, wherein the UE transmits the second PRS configuration to a serving base station to enable the serving base station to forward the request to a location server.

26. The method of claim 21, wherein:
the first PRS configuration indicates a first set of downlink transmit beams for the plurality of PRS, transmission times of the first set of downlink transmit beams, or both, and
the second PRS configuration indicates a second set of downlink transmit beams for the plurality of PRS, transmission times of the second set of downlink transmit beams, or both.

27. A method of communication performed by a location server, comprising:
transmitting, to a network node, a first positioning reference signal (PRS) configuration for a plurality of PRS transmitted by a corresponding plurality of base stations, wherein the plurality of PRS are frequency-division multiplexed with each other; and
receiving, from the network node, a request to update the first PRS configuration to a second PRS configuration for the plurality of PRS, wherein the second PRS configuration enables a user equipment (UE) to use a same downlink receive beam for at least two of the plurality of base stations within a same time interval.

28. The method of claim 27, wherein the same time interval comprises one or more symbols, a slot, or a subframe.

29. The method of claim 27, wherein the network node is:
the UE, or
a serving base station for the UE.

30. The method of claim 27, further comprising:
transmitting the second PRS configuration to the plurality of base stations.

31. The method of claim 27, wherein:
the first PRS configuration indicates a first set of downlink transmit beams for the plurality of PRS, transmission times of the first set of downlink transmit beams, or both, and
the second PRS configuration indicates a second set of downlink transmit beams for the plurality of PRS, transmission times of the second set of downlink transmit beams, or both.

32. A user equipment (UE), comprising:
a memory;
at least one transceiver; and
at least one processor communicatively coupled to the memory and the at least one transceiver, the at least one processor configured to:
receive, via the at least one transceiver on a first downlink receive beam, one or more first positioning reference signals (PRS) transmitted by a first base station on a first downlink transmit beam;
attempt to receive, via the at least one transceiver on the first downlink receive beam, one or more second PRS transmitted by a set of base stations, other than the first base station, on a set of downlink transmit beams other than the first downlink transmit beam;
determine that one or more signal strength measurements of the one or more second PRS received on the first downlink receive beam are below a threshold; and
cause the at least one transceiver to transmit a request to update the set of downlink transmit beams or the first downlink transmit beam, to update transmission times of the set of downlink transmit beams or the first downlink transmit beam, or to establish a new beam pairing with the first base station, the set of base station, or both.

33. The UE of claim 32, wherein the at least one processor causes the at least one transceiver to transmit the request to the first base station to enable the first base station to forward the request to a location server.

34. The UE of claim 32, wherein:
the request is to update the set of downlink transmit beams to a second set of downlink transmit beams used by the set of base stations, and
the second set of downlink transmit beams is known by the UE to have better reception characteristics at the UE.

35. The UE of claim 32, wherein the request is to establish the new beam pairing with the set of base stations.

36. The UE of claim 35, wherein the request being to establish the new beam pairing with the set of base stations comprises the request being a beam acquisition request.

37. The UE of claim 32, wherein the at least one processor is further configured to:
cause the at least one transceiver to transmit a proposed PRS reconfiguration for a subset of all base stations configured to transmit PRS to the UE.

38. The UE of claim 37, wherein the at least one processor causes the at least one transceiver to transmit the proposed PRS reconfiguration based on:
the updated set of downlink transmit beams or the first downlink transmit beam, the updated transmission times of the set of downlink transmit beams or the first downlink transmit beam, or based on the new beam pairing with the first base station, the set of base stations, or both,
new signal strength measurements, or
a determination that the proposed PRS reconfiguration is better than a current PRS configuration for at least the first base station or the set of base stations from a downlink receive beam perspective.

39. The UE of claim 37, wherein the at least one processor causes the at least one transceiver to transmit the proposed PRS reconfiguration to the first base station to enable the first base station to forward the request to a location server.

40. The UE of claim 37, wherein the at least one processor causes the at least one transceiver to transmit the proposed PRS reconfiguration to a location server.

41. The UE of claim 32, wherein the one or more first PRS and the one or more second PRS are frequency-division multiplexed with each other.

42. A location server, comprising:
a memory;
at least one network interface; and
at least one processor communicatively coupled to the memory and the at least one network interface, the at least one processor configured to:
configure, via the at least one network interface, a user equipment (UE) to measure one or more first positioning reference signals (PRS) transmitted by a first base station on a first downlink transmit beam and one or more second PRS transmitted by a set of base stations, other than the first base station, on a set of downlink transmit beams other than the first downlink transmit beam; and
receive, via the at least one network interface, a request to update the set of downlink transmit beams or the first downlink transmit beam, to update transmission times of the set of downlink transmit beams or the first downlink transmit beam, or to establish a new beam pairing with the first base station, the set of base stations, or both.

43. The location server of claim 42, wherein the at least one processor receives the request from the first base station via the at least one network interface.

44. The location server of claim 42, wherein:
the request is to update the set of downlink transmit beams to a second set of downlink transmit beams used by the set of base stations, and
the second set of downlink transmit beams is known by the UE to have better reception characteristics at the UE.

45. The location server of claim 42, wherein the request is to establish the new beam pairing with the set of base stations.

46. The location server of claim 45, wherein the request being to establish the new beam pairing with the set of base stations comprises the request being a beam acquisition request.

47. The location server of claim 42, wherein the at least one processor is further configured to:
receive, via the at least one network interface, a proposed PRS reconfiguration for a subset of all base stations configured to transmit PRS to the UE.

48. The location server of claim 47, wherein the at least one processor receives the proposed PRS reconfiguration via the at least one network interface based on:
the updated set of downlink transmit beams or the first downlink transmit beam, the updated transmission times of the set of downlink transmit beams or the first downlink transmit beam, or based on the new beam pairing with the first base station, the set of base stations, or both,
new signal strength measurements, or
a determination by the UE that the proposed PRS reconfiguration is better than a current PRS configuration for at least the first base station or the set of base stations from a downlink receive beam perspective.

49. The location server of claim 48, wherein the at least one processor receives the proposed PRS reconfiguration from the first base station via the at least one network interface.

50. The location server of claim 48, wherein the at least one processor receives the proposed PRS reconfiguration from the UE via the at least one network interface.

51. The location server of claim 42, wherein the one or more first PRS and the one or more second PRS are frequency-division multiplexed with each other.

52. A user equipment (UE), comprising:
a memory;
at least one transceiver; and
at least one processor communicatively coupled to the memory and the at least one transceiver, the at least one processor configured to:
receive, from a network entity via the at least one transceiver on, a first positioning reference signal (PRS) configuration for a plurality of PRS transmitted by a corresponding plurality of base stations, wherein the plurality of PRS are frequency-division multiplexed with each other;
determine a downlink receive beam for each of the plurality of base stations;
determine a second PRS configuration for the plurality of PRS that enables the UE to use a same downlink receive beam for at least two of the plurality of base stations within a same time interval; and
cause the at least one transceiver to transmit, to the network entity, the second PRS configuration for the plurality of PRS.

53. The UE of claim 52, wherein the same time interval comprises one or more symbols, a slot, or a subframe.

54. The UE of claim 52, wherein the downlink receive beam for each of the plurality of base stations is a downlink receive beam that enables the UE to receive the corresponding PRS on a shortest path between the UE and the base station.

55. The UE of claim 52, wherein the network entity is:
a location server, or
a serving base station.

56. The UE of claim 52, wherein the at least one processor causes the at least one transceiver to transmit the second PRS configuration to a serving base station to enable the serving base station to forward the request to a location server.

57. The UE of claim 52, wherein:
the first PRS configuration indicates a first set of downlink transmit beams for the plurality of PRS, transmission times of the first set of downlink transmit beams, or both, and
the second PRS configuration indicates a second set of downlink transmit beams for the plurality of PRS, transmission times of the second set of downlink transmit beams, or both.

58. A location server, comprising:
a memory;
at least one network interface; and
at least one processor communicatively coupled to the memory and the at least one network interface, the at least one processor configured to:
cause the at least one network interface to transmit, to a network node, a first positioning reference signal (PRS) configuration for a plurality of PRS transmitted by a corresponding plurality of base stations, wherein the plurality of PRS are frequency-division multiplexed with each other; and
receive, from the network node via the at least one network interface, a request to update the first PRS configuration to a second PRS configuration for the plurality of PRS, wherein the second PRS configuration enables a user equipment (UE) to use a same downlink receive beam for at least two of the plurality of base stations within a same time interval.

59. The location server of claim 58, wherein the same time interval comprises one or more symbols, a slot, or a subframe.

60. The location server of claim 58, wherein the network node is:
the UE, or
a serving base station for the UE.

61. The location server of claim 58, wherein the at least one processor is further configured to:
cause the at least one network interface to transmit the second PRS configuration to the plurality of base stations.

62. The location server of claim 58, wherein:
the first PRS configuration indicates a first set of downlink transmit beams for the plurality of PRS, transmission times of the first set of downlink transmit beams, or both, and
the second PRS configuration indicates a second set of downlink transmit beams for the plurality of PRS, transmission times of the second set of downlink transmit beams, or both.

63-75. (canceled)
